(19) United States
(12) Patent Application Publication
(10) Pub. No.: US 2025/0163333 A1
(43) Pub. Date: May 22, 2025

(54) METHODS AND SYSTEMS FOR DISPERSING CATALYST PRECURSORS INTO HYDROCARBON FEEDSTOCKS TO FORM CONDITIONED FEEDSTOCKS CONTAINNG NONPETROLEUM-DERIVED HYDROCARBONS

(71) Applicant: HYDROCARBON TECHNOLOGY & INNOVATION, LLC, Lawrenceville, NJ (US)

(72) Inventors: David M. Mountainland, Princeton, NJ (US); Brett M. Silverman, Salt Lake City, UT (US); Paul Sadelski, Plainsboro Township, NJ (US)

(21) Appl. No.: 18/942,206

(22) Filed: Nov. 8, 2024

Related U.S. Application Data
(60) Provisional application No. 63/599,684, filed on Nov. 16, 2023.

(51) Int. Cl. C10G 1/10; B01J 31/12; B01J 37/08

(52) U.S. Cl. CPC C10G 1/10; B01J 31/12; B01J 37/082; C10G 2300/1007; C10G 2300/1011; C10G 2300/703

(57) ABSTRACT

System and method for mixing a catalyst precursor into a carrier oil to form a diluted precursor mixture and mixing the diluted precursor mixture with a hydrocarbon feedstock to form a conditioned hydrocarbon feedstock containing at least one nonpetroleum-derived hydrocarbon material. Suitable mixing apparatus include static inline and high shear mixers. The conditioned hydrocarbon feedstock can be heated to thermally decompose the catalyst precursor and form dispersed active catalyst particles in situ. At least one of the carrier oil or hydrocarbon feedstock comprises a nonpetroleum-derived hydrocarbon material selected from biomass-derived material, nonpetroleum-derived oil or fat, polymer, fabric or textile, paper or cardboard, rubber, waste product, pyrolysis product of one or more of the foregoing, and combinations thereof. The hydrocarbon feedstock may be provided by primary and secondary hydrocarbon feedstocks that differ from each other by at least one of chemical composition, polarity, solubility, or physical state.

### CROSS REFERENCE TO RELATED APPLICATION

This Application claims the benefit of U.S. Provisional Application No. 63/599,684, filed Nov. 16, 2023, which is incorporated by reference in its entirety.

### BACKGROUND OF THE INVENTION

### 1. The Field of the Invention

The invention relates to methods and systems for dispersing catalyst precursors into hydrocarbon feedstocks to form conditioned hydrocarbon feedstocks containing nonpetroleum-derived hydrocarbons for subsequent processing, such as hydroprocessing, hydroconversion, hydrocracking, hydrotreating, solvent deasphalting, and/or coking.

### 2. The Relevant Technology

Converting heavy oil into useful end products involves extensive processing, such as reducing the boiling point of the heavy oil, increasing the hydrogen-to-carbon ratio, and removing impurities such as metals, sulfur, nitrogen, and coke precursors. Examples of hydrocracking processes using conventional heterogeneous catalysts to upgrade atmospheric tower bottoms and/or vacuum tower bottoms include fixed bed hydroprocessing, ebullated bed hydroprocessing, slurry bed hydroprocessing, and moving bed hydroprocessing. Hydrocracking can also be performed using a homogeneous catalyst in a slurry bed reactor.

There is an ever-increasing demand to more efficiently utilize low quality heavy oil feedstocks and extract fuel values therefrom. Low quality feedstocks are characterized as including relatively high quantities of hydrocarbons that nominally boil at or above 524° C. (975° F.). They also contain relatively high concentrations of asphaltenes, sulfur, nitrogen and metals. High boiling fractions derived from these low-quality feedstocks typically have a high molecular weight (often indicated by higher density and viscosity) and/or low hydrogen/carbon ratio, which is related to the presence of high concentrations of undesirable components, including asphaltenes and carbon residue. Asphaltenes and carbon residue are difficult to process and commonly cause fouling of conventional catalysts and hydroconversion equipment because they contribute to the formation of coke and sediment.

Low quality heavy oil feedstocks contain high concentrations of asphaltenes, carbon residue, sulfur, nitrogen, and metals. Examples include heavy crude, oil sands bitumen, and residuum left over from conventional refinery process. Residuum (or “resid”) can refer to atmospheric tower bottoms and vacuum tower bottoms. Atmospheric tower bottoms can have a boiling point of at least 343° C. (650° F.) although it is understood that the cut point can vary among refineries and be as high as 380° C. (716° F.). Vacuum tower bottoms (also known as “resid pitch” or “vacuum residue”) can have a boiling point of at least 524° C. (975° F.), although it is understood that the cut point can vary among refineries and be as high as 538° C. (1000° F.) or even 565° C. (1050° F.).

Increasingly, there is a need to process nonpetroleum-derived feedstocks for the production of liquid and gas products, such as fuels and chemicals. These nonpetroleum-derived feedstocks can include bio-derived materials, referred to as biomass (e.g., plant matter). Non-petroleum-derived feedstocks can also include plastics, such as high-density polyethylene, low-density polyethylene, polystyrene, polyethylene terephthalate, polypropylene, bisphenol-A, and/or polyvinyl chloride. They can also include waste or recycled material such as used cooking oil, plant-derived fats, animal-derived fats, rubber (especially waste tires), fabrics (textiles), paper or cardboard fiber, municipal solid waste, and sewage sludge. Any of the aforementioned categories can further include partially converted materials created from the listed non-petroleum feedstocks, which have been processed using techniques such as pyrolysis, cracking, coking, or the like.

In many cases, it may be desirable to form a mixture of two or more dissimilar hydrocarbon feedstocks that differ with respect to chemical composition, polarity, solubility, and/or physical state, making them somewhat or very difficult to mix to form sufficiently stable and/or homogeneous a conditioned hydrocarbon feedstock. While not always required, it will sometimes be advantageous to process one or more nonpetroleum-derived materials as a mixture with a more “conventional” feedstock, typically a petroleum-derived material such as vacuum residue, vacuum gas oil, or other fractions from petroleum processing that are known in the art. Conventional feedstock materials can provide a uniform liquid matrix for the processing of the mixture and can provide useful hydrocarbon components which contribute to the formation of desired products when the mixture is converted and refined.

Alternatively, it may be advantageous in some cases to combine two or more feedstocks derived from nonpetroleum sources and omit the use of conventional petroleum-derived materials. When nonpetroleum-derived hydrocarbon feedstocks are converted in one or more suitable downstream processes, the capacity is maximized for the conversion of recycled or biomass-derived components.

However, a significant problem encountered when processing nonpetroleum-derived feedstocks is the difficulty of forming stable liquid mixtures, which can be readily processed using typical conversion and refining equipment. Nonpetroleum-derived feedstocks often have significant differences in chemical composition, polarity, solubility, physical state (e.g., liquid versus solid), and other properties relative to petroleum-derived feedstocks, and also relative to other types of nonpetroleum-derived feedstocks, making it difficult to produce stable mixtures that are amenable to processing.

In a typical hydroprocessing system (e.g., ebullated bed, fixed bed, and slurry bed), the rate of production of converted products is often limited by fouling. When attempts are made to increase the production of converted products beyond a certain practical limit, the rate of fouling of mixers, heat exchangers, strainers, and other process equipment becomes too rapid, requiring more frequent shutdowns for maintenance and cleaning. A refinery operator typically relates the observed rate of equipment fouling to measurements of sediment production and arrives at an operating sediment limit, above which the refinery will avoid operating the hydrocracking reactor. Thus, sediment production and equipment fouling place practical upper limits on conversion and the rate of production of converted products. Such problems are exacerbated when using lower quality heavy oil feedstocks, and may be further exacerbated when one or more nonpetroleum-derived feedstock materials are included.

Ebullated bed and fixed bed reactors that utilize a dual catalyst system comprised of a heterogeneous catalyst and a dispersed (e.g., metal sulfide) catalyst have been used to reduce equipment fouling and/or permit an increase in the rate of production of converted products. The success or failure of the dual catalyst system depends on several variables, including the particle size of the dispersed catalyst, which is the result of how it is formed. In the case of a metal sulfide catalyst formed from a catalyst precursor, the size and activity of the resulting catalyst is based primarily on how well it was dispersed into the heavy oil before thermally decomposing to form the active catalyst. Unless the catalyst precursor is adequately dispersed into the heavy oil prior to thermal decomposition, the resulting metal sulfide catalyst particles formed within the heavy oil feedstock will have low catalytic activity and may actually cause more equipment fouling, thus negating its effectiveness as a catalyst.

When employing a dispersed catalyst to enhance the performance of hydroprocessing system (e.g., ebullated bed, fixed bed, or slurry bed), it is preferable to first prepare a diluted precursor mixture, which is thereafter mixed with the heavy oil feedstock. This is prepared by mixing a catalyst precursor with a hydrocarbon diluent, which is selected based on availability, cost, suitability for addition to the hydroprocessing process, and ability to solubilize the precursor. Such a diluted precursor mixture is more easily dispersed in the bulk of the heavy oil feedstock compared to directly mixing the precursor with the heavy oil feedstock. It can be difficult to adequately mix a catalyst precursor by simply adding it to the heavy oil feed, which yields a poorly mixed material that is likely to result in the formation of undesirably large or agglomerated catalyst particles when the dispersed catalyst is subsequently activated by heating of the feedstock mixture.

Some have used low and medium boiling hydrocarbons as a diluent for a catalyst precursor to form a diluted precursor mixture, which is then mixed into the heavy oil feedstock. Materials such as startup diesel, vacuum gas oil, atmospheric gas oil, decant oil, cycle oil, or the like are suitable medium boiling diluents. These materials have nominal boiling points in the range of 200° C. to 524° C. and have good solubility for the dispersed catalyst precursor. In addition, they are commonly processed and/or stored in a temperature range that makes them suitable for use as a diluent without further processing. This is because it is advantageous to use the diluent at a temperature below the decomposition temperature of the catalyst precursor, so that the precursor may be fully dissolved and dispersed before significant decomposition of the precursor and activation of dispersed metal sulfide catalyst particles occur.

While high quality hydrocarbon diluents have been effective in forming diluted precursor mixtures, it may be desirable to use other carrier oils. For example, available medium boiling materials, such as gas oil, may have significant value for commercial sale, or for the production of salable products, such that they are effectively too expensive to enable their use as a diluent, particularly at higher quantities. Potential medium boiling materials may be required as feeds or intermediates for other processing systems in a commercial complex, making them unavailable for use as diluent. Thus, it may be desirable to supplement or replace high quality hydrocarbon diluents with alternative materials.

For example, it may be desirable to use nonpetroleum-derived carrier oils when high quality hydrocarbon diluents are either unavailable or relatively expensive and more valuable when used as end products. In addition, it may be desirable for the carrier oil to comprise up to 50% of the hydrocarbon feedstock material used in upgrading processes. In such cases, it would be wasteful and not economically viable to use high quality hydrocarbon diluents that are in short supply, more expensive, and not in need of further conversion or upgrading. In such cases, the use of one or more nonpetroleum-derived carrier oils that require further upgrading to form valuable end products would be attractive when using larger quantities of carrier oil to make diluted precursor mixtures. However, it is expected that significant problems may arise if nonpetroleum-derived carrier oils were used instead of or in addition to high quality hydrocarbon diluents to form diluted precursor mixtures.

### SUMMARY

Disclosed herein are methods and systems configured to mix a catalyst precursor into a carrier oil to form a diluted precursor mixture and mixing the diluted precursor mixture with a hydrocarbon feedstock to form a conditioned hydrocarbon feedstock containing at least one nonpetroleum-derived hydrocarbon material. The conditioned feedstock can be heated to thermally decompose the catalyst precursor and form dispersed metal sulfide catalyst particles in situ, which have high catalytic activity and promote beneficial upgrading reactions when hydroprocessing the hydrocarbon feedstock.

The disclosed methods and systems provide for efficient use of a dispersed catalyst used in downstream processing systems when it is desired to utilize a nonpetroleum-derived hydrocarbon carrier oil to replace at least a portion of conventional hydrocarbon diluents and/or when it is desired to utilize one or more nonpetroleum derived hydrocarbon feedstock materials to replace at least a portion of conventional petroleum-derived feedstocks, such as heavy oil. In some embodiments, nonpetroleum derived material or materials may form all or part of the carrier oil, all or part of the hydrocarbon feedstock, or both.

At least one of the hydrocarbon carrier oil or hydrocarbon feedstock material comprises a nonpetroleum-derived hydrocarbon material selected from biomass-derived material, nonpetroleum-derived oil or fat, polymer, fabric or textile, paper or cardboard, rubber, waste product, pyrolysis product of one or more of the foregoing, and combinations thereof. At least one of the hydrocarbon carrier oil or hydrocarbon feedstock material may comprise a petroleum-derived hydrocarbon material, such as a conventional hydrocarbon diluent for the carrier oil and a conventional heavy oil for the hydrocarbon feedstock material.

In some embodiments, mixing of the catalyst precursor with the carrier oil to form a diluted precursor mixture can be performed by one or more static inline mixers. In some embodiments, blending of the diluted precursor mixture with the hydrocarbon feedstock material can be performed by one or more static inline mixers to form an intermediate feedstock blend, which is further mixed by one or more high shear mixers to form a conditioned hydrocarbon feedstock for subsequent processing, such as one or more of hydrocracking or hydroconversion (e.g., by ebullated bed, fixed bed, or slurry bed reactor), solvent deasphalting, coking (delayed coking and/or Flexicoking), fluid catalytic cracking, hydroprocessing, or hydrotreating.

An example method for dispersing a catalyst precursor into a hydrocarbon feedstock to form a conditioned hydrocarbon feedstock containing at least one nonpetroleum-derived hydrocarbon material for subsequent processing comprises:
(1) mixing a catalyst precursor with a hydrocarbon carrier oil by one or more static inline mixers to form a diluted precursor mixture; and
(2) blending the diluted precursor mixture with a primary hydrocarbon feedstock material, and optionally a secondary hydrocarbon feedstock material, by one or more static inline mixers and one or more high shear mixers to form the conditioned hydrocarbon feedstock,
(3) wherein the hydrocarbon carrier oil, the primary hydrocarbon feedstock material, and the optional secondary hydrocarbon feedstock material are independently selected from the group consisting of biomass-derived material, nonpetroleum-derived oil or fat, polymer, fabric or textile, paper or cardboard, rubber, waste product, pyrolysis product of one or more of the foregoing, petroleum-derived material, and combinations thereof, and
(4) wherein at least one of the hydrocarbon carrier oil, the primary hydrocarbon feedstock material, or the optional secondary hydrocarbon feedstock material comprises a nonpetroleum-derived hydrocarbon material.

In some embodiments, the hydrocarbon carrier oil and the primary hydrocarbon feedstock material differ from each other by at least one of chemical composition, polarity, solubility, or physical state.

In some embodiments, the method further comprises blending the optional secondary hydrocarbon feedstock material with the diluted precursor mixture and the primary hydrocarbon feedstock material to form the conditioned hydrocarbon feedstock. When used, the secondary hydrocarbon feedstock material can differ from the primary hydrocarbon feedstock material by at least one of chemical composition, polarity, solubility, or physical state, and wherein the secondary hydrocarbon feedstock material is selected from the group consisting of biomass-derived material, nonpetroleum-derived oil or fat, polymer, fabric or textile, paper or cardboard, rubber, waste product, pyrolysis product of one or more of the foregoing, petroleum-derived material, and combinations thereof, and wherein at least one of the primary hydrocarbon feedstock material or the secondary hydrocarbon feedstock material comprises a nonpetroleum-derived hydrocarbon.

In some embodiments, such as where one or more nonpetroleum-derived materials are solid at the temperature at which they are mixed with one or more other hydrocarbon materials, it can be advantageous to liquify and/or comminute any initially solid hydrocarbon materials to a particle size of about 50 mesh (about 300 μm) or smaller, or about 70 mesh (about 210 μm) or smaller, or about 100 mesh (about 150 μm) or smaller.

In some embodiments, the catalyst precursor comprises an oil-soluble organometallic compound or complex having a decomposition temperature in a range from about 100° C. to about 350° C. and that is comprised of at least one transition metal and at least one organic acid, carbonyl, or derivative thereof. For example, the catalyst precursor may comprise a transition metal selected from the group consisting of molybdenum, nickel, cobalt, vanadium, tungsten, iron, and combinations thereof and a carboxylic acid or derivative thereof selected from the group consisting of 2-ethylhexanoic acid, octanoic acid, naphthenic acid, 3-cyclopentylpropionic acid, cyclohexanebutyric acid, biphenyl-2-carboxylic acid, 4-heptylbenzoic acid, 5-phenylvaleric acid, geranic acid (3,7-dimethyl-2,6-octadienoic acid), 10-undecenoic acid, dodecanoic acid, and combinations thereof.

In some embodiments, the carrier oil used to make the diluted precursor mixture may include a petroleum-derived material or a nonpetroleum-derived material such as any of the hydrocarbon feedstock materials used to form the conditioned hydrocarbon feedstock. In some embodiments, the carrier oil may include at least one of atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C.

The conditioned hydrocarbon feedstock with dispersed catalyst precursor can be passed through a heater to decompose at least a portion of the catalyst precursor and form dispersed metal sulfide catalyst particles in situ within the hydrocarbon feedstock prior to entering a hydroprocessing reactor. For example, the conditioned hydrocarbon feedstock can be removed from a surge tank (e.g., warm surge tank) and passed through a heater. Alternatively, or in addition, at least a portion of the conditioned hydrocarbon feedstock can be heated within the hydroprocessing reactor itself to decompose at least a portion of the catalyst precursor and form dispersed metal sulfide catalyst particles in situ within the hydrocarbon feedstock. It has been found that preheating the conditioned hydrocarbon feedstock upstream from the hydroprocessing reactor yields a more active dispersed catalyst.

In some embodiments, the dispersed metal sulfide catalyst particles are less than 1 μm in size, or less than about 500 nm in size, or less than about 250 nm in size, or less than about 100 nm in size, or less than about 50 nm in size, or less than about 25 nm in size, or less than about 10 nm in size, or less than about 5 nm in size.

In some embodiments, the diluted catalyst precursor mixture and hydrocarbon feedstock materials can be mixed using a single mixing line to form the conditioned hydrocarbon feedstock. In some embodiments, the hydrocarbon components can be mixed using a plurality of (e.g., two) parallel mixing lines, each parallel mixing line including one or more static inline mixers, one or more high shear mixers, and at least one valve for regulating flow in the mixing line. Example methods and systems for blending hydrocarbon components that incorporate two or more parallel mixing lines are disclosed in U.S. Pub. No. 2023/0383198, which is incorporated by reference in its entirety. An advantage of using two or more parallel mixing lines is that one of the mixing lines can be taken offline for maintenance without having to shut down the entire system, with the other mixing line(s) continuing to operate.

In some embodiments, it may be desirable to recycle a portion of the conditioned hydrocarbon feedstock back into the mixing system, such as by combining the recycled portion with at least one of the carrier oil, diluted precursor mixture, or hydrocarbon feedstock material(s).

In some embodiments, the hydrocarbon feedstock with in situ formed dispersed metal sulfide catalyst can be hydroprocessed at hydroprocessing conditions, wherein the dispersed metal sulfide catalyst promotes beneficial hydrogenation and other upgrading reactions in the presence of heat and hydrogen. Hydroprocessing can be performed by one or more hydroprocessing reactors selected from slurry phase reactors, ebullated bed reactors, and fixed bed reactors.

For example, hydroprocessing of the hydrocarbon feedstock can be performed using one or more hydroprocessing reactors (e.g., ebullated bed or fixed bed) that utilize the dispersed metal sulfide catalyst in combination with a heterogenous ebullated bed catalyst to produce converted products. Instead of or in addition to the one or more ebullated bed reactors, hydroprocessing of the hydrocarbon feedstock can be performed using one or more slurry phase reactors that utilize the dispersed metal sulfide catalyst as the sole catalyst or in combination with a conventional slurry catalyst, and/or one or more fixed bed reactors that utilize the dispersed metal sulfide catalyst in combination with a heterogenous fixed bed catalyst.

Following hydroprocessing of the hydrocarbon feedstock, the upgraded hydrocarbon material can be separated into one or more lower boiling hydrocarbon fractions and one or more liquid hydrocarbon fractions. For example, the upgraded hydrocarbon material can be separated using one or more hot separation units, an interstage separator that induces a pressure drop, an atmospheric distillation tower, or a vacuum distillation tower.

Systems for dispersing a catalyst precursor into a hydrocarbon feedstock to form a conditioned hydrocarbon feedstock containing at least one nonpetroleum-derived hydrocarbon material to form a conditioned hydrocarbon feedstock for subsequent processing comprise means for performing the method steps disclosed herein. In addition to supply lines and mixers, such as the static-inline mixers and high shear mixers discussed herein, the system may further comprise processing equipment selected from the group consisting of strainers, filters, pumps, furnaces, heat exchangers, reactors, separators, tanks, and distillation columns.

An example system for dispersing a catalyst precursor into a hydrocarbon feedstock to form a conditioned hydrocarbon feedstock containing at least one nonpetroleum-derived hydrocarbon material for subsequent processing comprises:
(1) a supply line for each of a catalyst precursor, a hydrocarbon carrier oil, a primary hydrocarbon feedstock material, and optionally a secondary hydrocarbon material;
(2) one or more static in-line mixers configured to receive and mix the catalyst precursor with the carrier oil to form a diluted precursor mixture; and
(3) a mixing system configured to receive and mix the diluted precursor mixture with the primary hydrocarbon feedstock material and optionally the secondary hydrocarbon feedstock material to form the conditioned hydrocarbon feedstock, the mixing system comprising one or more static in-line mixtures and one or more high shear mixers;
(4) wherein the hydrocarbon carrier oil, the primary hydrocarbon feedstock material, and the optional secondary hydrocarbon feedstock material are independently selected from the group consisting of biomass-derived material, nonpetroleum-derived oil or fat, polymer, fabric or textile, paper or cardboard, rubber, waste product, pyrolysis product of one or more of the foregoing, petroleum-derived material, and combinations thereof, and
(5) wherein at least one of the hydrocarbon carrier oil, the primary hydrocarbon feedstock material, or the optional secondary hydrocarbon feedstock material comprises a nonpetroleum-derived hydrocarbon material.

The methods and systems may include a plurality of different mixers and/or different types of mixers, such as static inline mixers, high shear mixers, surge tank(s) with pump around, and pumps used to feed the conditioned hydrocarbon feedstock to hydroprocessing or other reactor(s).

These and other advantages and features of the present invention will become more fully apparent from the following description and appended claims or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings, in which:

FIG. 1 schematically illustrates an exemplary mixing system for mixing a catalyst precursor with a carrier oil to form a diluted precursor mixture and mixing the diluted precursor mixture with a hydrocarbon feedstock to form a conditioned hydrocarbon feedstock;

FIG. 2 schematically illustrates an exemplary mixing system for mixing a catalyst precursor with a carrier oil to form a diluted precursor mixture and mixing the diluted precursor mixture with primary and secondary hydrocarbon feedstocks to form a conditioned hydrocarbon feedstock;

FIG. 3 schematically illustrates an exemplary mixing system having parallel mixing lines and a bypass line for mixing a catalyst precursor with a carrier oil to form a diluted precursor mixture and mixing the diluted precursor mixture with a hydrocarbon feedstock to form a conditioned hydrocarbon feedstock;

FIG. 4 schematically illustrates an exemplary mixing system having parallel mixing lines and a bypass line for mixing a catalyst precursor with a carrier oil to form a diluted precursor mixture and mixing the diluted precursor mixture with primary and secondary hydrocarbon feedstocks to form a conditioned hydrocarbon feedstock;

FIG. 5 schematically illustrates an exemplary mixing and pumping system for preparing and pressurizing a conditioned hydrocarbon feedstock in preparation for downstream processing;

FIG. 6 schematically illustrates an exemplary ebullated bed hydroprocessing system using a dual catalyst system that can be used to hydroprocess hydrocarbon feedstocks;

FIG. 7 schematically illustrates an exemplary ebullated bed reactor with external recycling pump and a separator unit that separates volatilizable materials from non-volatilizable materials;

FIG. 8 schematically illustrates an exemplary slurry phase hydroprocessing system with internal recycling pump that can be used to hydroprocess hydrocarbon feedstocks; and

FIG. 9 schematically illustrates an exemplary hydroprocessing system that includes a hydroprocessing reactor, a separator unit that separates volatilizable materials from non-volatilizable materials, and a fixed bed reactor for further hydroprocessing the non-volatilizable materials.

### DETAILED DESCRIPTION OF THE PREFERRED EMBODIMENTS

### I. Introduction

Disclosed herein are methods and systems configured to mix a catalyst precursor into a carrier oil to form a diluted precursor mixture and mixing the diluted precursor mixture with a hydrocarbon feedstock to form a conditioned hydrocarbon feedstock containing at least one nonpetroleum-derived hydrocarbon material. The conditioned feedstock can be heated to thermally decompose the catalyst precursor and form dispersed metal sulfide catalyst particles in situ, which have high catalytic activity and promote beneficial upgrading reactions when hydroprocessing the hydrocarbon feedstock.

The disclosed methods and systems provide for efficient use of a dispersed catalyst used in downstream processing systems when it is desired to utilize a nonpetroleum-derived hydrocarbon carrier oil to replace at least a portion of conventional hydrocarbon diluents and/or when it is desired to utilize one or more nonpetroleum derived hydrocarbon feedstock materials to replace at least a portion of conventional petroleum-derived feedstocks, such as heavy oil.

At least one of the hydrocarbon carrier oil or hydrocarbon feedstock material comprises a nonpetroleum-derived hydrocarbon material selected from biomass-derived material, nonpetroleum-derived oil or fat, polymer, fabric or textile, paper or cardboard, rubber, waste product, pyrolysis product of one or more of the foregoing, and combinations thereof. At least one of the hydrocarbon carrier oil or hydrocarbon feedstock material may comprise a petroleum-derived hydrocarbon material, such as a conventional hydrocarbon diluent for the carrier oil and a conventional heavy oil for the hydrocarbon feedstock material.

In some embodiments, mixing of the catalyst precursor with the carrier oil to form a diluted precursor mixture can be performed by one or more static inline mixers. In some embodiments, blending of the diluted precursor mixture with the hydrocarbon feedstock material can be performed by one or more static inline mixers to form an intermediate feedstock blend, which is further mixed by one or more high shear mixers to form a conditioned hydrocarbon feedstock for subsequent processing, such as one or more of hydrocracking or hydroconversion (e.g., by ebullated bed, fixed bed, or slurry bed reactor), solvent deasphalting, coking (delayed coking and/or Flexicoking), fluid catalytic cracking, hydroprocessing, or hydrotreating.

### II. Definitions

The term “dissimilar hydrocarbon materials” refers to two or more carrier oils and/or hydrocarbon feedstock materials which differ from each other with respect to chemical composition, polarity, solubility, and/or physical state. Examples of hydrocarbon feedstock materials that can be used in the disclosed processes and that may differ with respect to one or more of the foregoing properties include one or more of biomass-derived materials, nonpetroleum-derived oils or fats, polymers, fabrics or textiles, paper or cardboard, rubber, waste products, pyrolysis products of the foregoing, petroleum-derived materials, or combinations thereof.

### A. Nonpetroleum-Derived Hydrocarbon Carrier Oils and Feedstock Materials

The term “biomass-derived material” refers to hydrocarbon-containing materials that are, contain, or come from biomass. “Biomass” is a term used in several contexts. In the context of ecology, it means living organisms, and in the context of bioenergy it means matter from recently living (but now dead) organisms. In the latter context, there are variations in how biomass is defined, e.g., only from plants, or from plants and algae, or from plants and fungi. The vast majority of biomass used for bioenergy and other processes, such as manufacturing biopolymers, comes from plants. Examples of biomass-derived materials that can be mixed and processed by methods and systems disclosed herein include, but are not limited to, plant-derived material, lignocellulose, cellulose, lignin, starch, wood, wood residues, sawdust, wood chips, energy crops, hemp, straw, wheat straw, barley straw, stover, grasses, switch grass, maize, miscanthus, bamboo, husks, bagasse, silage, agriculture waste, seaweed, kelp, algae, pyrolysis products of one or more of the foregoing, and combinations thereof.

The term “nonpetroleum-derived oil or fat” refers to any oil or fat that generally comes or is derived from living organisms, such as plants and animals. Examples of nonpetroleum-derived oils or fats that can be mixed and processed by methods and systems disclosed herein include, but are not limited to, vegetable oils and fats, animal fats and proteins, used cooking oil, seed oils, nonpetroleum waxes, pyrolysis products of one or more of the foregoing, and combinations thereof.

The terms “plastic” and “polymer” refer to polymeric materials comprising repeating units, including homopolymers containing monomers bonded together as repeating units, copolymers containing multiple monomers bonded together in repeating units or blocks. The term ‘plastic” typically refers to thermoplastic polymers that have a melting or softening point and can be molded by heating to above the melting or softening point, forming the melt into a desired shape, and cooling the plastic in the desired molded shape. The term polymer more broadly covers thermoplastic polymers, as defined above, and thermoset polymers, which are typically provided as a resin that is formed into a desired shape and then caused to polymerize and/or cross-link via chemical and/or photoinitiation reactions. Examples of plastics and polymers that can be mixed and processed by methods and systems disclosed herein include, but are not limited to, high-density polyethylene (HDPE), low-density polyethylene (LDPE), polypropylene (PP), polystyrene (PS), polyester (PE), polyethylene terephthalate (PET), polybutylene terephthalate (PBT), polyetheretherketone (PEEK), polycarbonate (PC), acrylic, polymethacrylate, biopolymer, phenol-formaldehyde condensate, polyvinylchloride (PVC), bisphenyl-A, polyurethane (PUR), bioplastics, polyhydroxyalkanoate (PHA), polyhydroxy-butyrate (PHB), pyrolysis products of one or more of the foregoing, and combinations thereof.

The terms “fabric” and “textile” generally refer to finished or semi-finished products made from one or different types of fibers, such as natural fibers and/or synthetic fibers. Fabrics and textiles can be made from one or more different types of yarns or other fiber-based threads or materials include weaves, knits, non-wovens, and other fibrous structures joined together by one or more processes such as weaving, knitting, spreading, felting, stitching, crocheting, or bonding. Fibers used to make fabrics and textiles include natural fibers, synthetic fibers, and blends thereof. Examples of fabrics and textiles that can be mixed and processed by methods and systems disclosed herein include, but are not limited to cloth, clothing, towels, rags, upholstery, carpet, geotextiles, drapes, shades, blinds, baskets, tablecloths, bedding, sheets, blankets, shower curtains, flags, backpacks, tents, nets, balloons, kites, sails, and parachutes. Examples of materials used to make or which are derived from fabrics and textiles that can be mixed and processed by methods and systems disclosed herein include, but are not limited to, cotton, polyester, linen, jute, nylon, spandex, wool, silk, leather, other fabrics, pyrolysis products of one or more of the foregoing, and combinations thereof.

The terms “paper” and “cardboard” generally refer to a wide range of products made by mechanically or chemically processing cellulose fibers derived from wood, rags, grasses, or other vegetable sources in water, draining the water through a fine mesh leaving the fibers evenly distributed on the surface, followed by pressing and drying. Paper is a versatile material with many uses, including printing, painting, graphics, signage, design, packaging, decorating, writing, and cleaning. It may also be used as filter paper, wallpaper, book endpaper, conservation paper, laminated worktops, toilet tissue, currency, and security paper, or in a number of industrial and construction processes. Cardboard is a generic term for heavy paper-based products. The construction can range from a thick paper known as paperboard to corrugated fiberboard which is made of multiple plies of material. Natural cardboard can range from grey to light brown in color, depending on the specific product, and may contain dyes, pigments, printing, and coatings.

The terms “rubber” and “elastomer” refer to polymers with viscoelasticity (i.e., both viscosity and elasticity) and with weak intermolecular forces, generally low Young's modulus (E) and high failure strain compared with other materials. “Elastomer” is a portmanteau of “elastic” and “polymer” and often used interchangeably with “rubber”, although the latter is preferred when referring to vulcanizates. Each of the monomers which link to form the polymer is usually a compound of several elements selected from carbon and/or silicon, hydrogen, oxygen. Rubber-like solids with elastic properties are called elastomers. Polymer chains are held together in these materials by relatively weak intermolecular bonds, which permit the polymers to stretch in response to macroscopic stresses. Elastomers are usually thermosets (requiring vulcanization) but may also be thermoplastic (see thermoplastic elastomer). The long polymer chains cross-link during curing (i.e., vulcanizing). The elasticity is derived from the ability of the long chains to reconfigure themselves to distribute an applied stress. The covalent cross-linkages ensure that the elastomer will return to its original configuration when the stress is removed. Examples of rubbers, elastomers, and products made therefrom that can be mixed and processed by methods and systems disclosed herein include, but are not limited to, isoprene, neoprene, tires (e.g., used tires), polybutadiene, styrene-butadiene copolymer, butyl rubber, ethylene propylene rubber, styrene-ethylene-butylene-styrene (SEBS), acrylic rubber, thermoplastic elastomer (TPE), pyrolysis products of one or more of the foregoing, and combinations thereof.

The term “waste product” refers to products that are discarded or discharged from various industrial or municipal waste sources. Examples of rubbers, elastomers, and products made therefrom that can be mixed and processed by methods and systems disclosed herein include, but are not limited to, municipal solid waste (MSW), sewage sludge, food processing waste, meat-processing waste, industrial waste products, pyrolysis products of one or more of the foregoing, and combinations thereof.

The term “pyrolysis product” refers to products produced by thermal decomposition of hydrocarbon materials at elevated temperatures, typically in an inert atmosphere. Temperature can be understood as thermal vibration. At high temperatures, excessive vibration causes long chain molecules to break into smaller molecules. The word is coined from the Greek-derived elements pyro (“fire” or “heat”) and lysis (“separating”). Pyrolysis is most commonly used in the treatment of organic materials. In general, pyrolysis of organic substances produces volatile products and leaves char, a carbon-rich solid residue. Extreme pyrolysis, which leaves mostly carbon as the residue, is called carbonization. Pyrolysis is considered the first step in the processes of gasification or combustion. The process is used in the chemical industry, for example, to produce ethylene, many forms of carbon, and other chemicals from petroleum, coal, and even wood, or to produce coke from coal. It is used also in the conversion of natural gas (primarily methane) into hydrogen gas and solid carbon char, recently introduced on an industrial scale. Pyrolysis can convert biomass into syngas and biochar, waste plastics back into usable oil, and other wastes into safely disposable substances after removal of potentially valuable distillation products.

Pyrolysis is one of various types of chemical degradation processes that occur at higher temperatures (above the boiling point of water or other solvents). It differs from other processes, like combustion and hydrolysis, in that it usually does not involve the addition of other reagents such as oxygen (in combustion) or water (in hydrolysis). Pyrolysis produces solids (char), condensable liquids, (light and heavy oils and tar), and non-condensable gasses. Pyrolysis is different from gasification. In the chemical process industry, pyrolysis refers to a partial thermal degradation of carbonaceous materials that takes place in an inert (oxygen free) atmosphere and produces gases, liquids, and solids. Pyrolysis can be extended to full gasification that produces mainly gaseous output, often with the addition of water (as steam) to gasify residual carbonic solids, such as in steam reforming.

There are different types of pyrolysis. Carbonization is the complete pyrolysis of organic matter, which usually leaves a solid residue that consists mostly of elemental carbon. Destructive distillation is used in the manufacture of charcoal, coke, and activated carbon. Charcoal burning is used to produce charcoal. Tar production is performed by destructive distillation of wood in tar kilns. Cracking is used to convert heavier hydrocarbons into lighter ones, as in oil refining. Thermal depolymerization is used to break down plastics and other polymers into monomers and oligomers. Catagenesis is the natural conversion of buried organic matter to fossil fuels. Flash vacuum pyrolysis is used in organic synthesis.

Pyrolysis oil, sometimes referred to as bio-crude or bio-oil, is a synthetic fuel under investigation as substitute for petroleum. It is obtained by heating dried biomass without oxygen in a reactor at a temperature of about 500° C. (900° F.) with subsequent cooling. Pyrolysis oil is a kind of tar and normally contains levels of oxygen too high to be considered a pure hydrocarbon. This high oxygen content results in non-volatility, corrosiveness, immiscibility with fossil fuels, thermal instability, and a tendency to polymerize when exposed to air. As such, it is distinctly different from petroleum products. Oxygen can be removed from bio-oil and nitrogen from algal bio-oil by hydrotreating to form upgraded hydrocarbon products.

### B. Petroleum-Derived Feedstock Materials and Related Processes

“Heavy oil” and “heavy oil feedstock” refer to heavy crude, oil sands bitumen, bottom of the barrel and residuum left over from refinery processes, such as visbreaker bottoms, and any other lower quality materials that contain a substantial quantity of high boiling hydrocarbon fractions and/or that include a significant quantity of asphaltenes that can deactivate a heterogeneous catalyst and/or cause or result in formation of coke precursors and sediment. Examples of heavy oils include, but are not limited to, Lloydminster heavy oil, Cold Lake bitumen, Athabasca bitumen, atmospheric tower bottoms, vacuum tower bottoms, residuum (or “resid”), resid pitch, vacuum residue (e.g., Ural VR, Arab Medium VR, Athabasca VR, Cold Lake VR, Maya VR, and Chichimene VR), pyrolysis oils, deasphalted liquids obtained by solvent deasphalting, asphaltene liquids obtained as a byproduct of deasphalting, and nonvolatile liquid fractions that remain after subjecting crude oil, bitumen from tar sands, liquefied coal, oil shale, or coal tar feedstocks to distillation, hot separation, solvent extraction, and the like. By way of further example, atmospheric tower bottoms (ATB) can have a nominal boiling point of at least 343° C. although it is understood that the cut point can vary among refineries and be as high as 380° C. Vacuum tower bottoms can have a nominal boiling point of at least 524° C., although it is understood that the cut point can vary among refineries and be as high as 538° C. or even 565° C.

“Asphaltene” and “asphaltenes” refer to materials in heavy oil that are insoluble in paraffinic solvents, such as propane, butane, pentane, hexane, and heptane. Asphaltenes can include sheets of condensed ring compounds held together by heteroatoms, such as sulfur, nitrogen, oxygen, and metals. Asphaltenes broadly include a wide range of complex compounds having from 80 to 1200 carbon atoms, with predominating molecular weights, as determined by solution techniques, in the 1200 to 16,900 range. About 80-90% of the metals in the crude oil are contained in the asphaltene fraction which, together with a higher concentration of non-metallic heteroatoms, render asphaltene molecules more hydrophilic and less hydrophobic than other hydrocarbons in heavy oil resids. In the case of nonpetroleum-derived hydrocarbon feedstocks, such as pyrolysis oil, there can be materials similar to petroleum-derived asphaltenes that are insoluble in heptane. For purposes of this disclosure, the terms “asphaltene” and “asphaltenes” shall refer to any hydrocarbon materials that are heptane insoluble.

“High boiling hydrocarbon material” and “high boiling hydrocarbon” refer to hydrocarbons at a processing facility that have a nominal boiling point of at least about 524° C. Examples include, but are not limited to, vacuum residues (produced from crude oil after a series of separation processes, including vacuum distillation), vacuum tower bottoms (produced downstream from one or more hydroprocessing reactors after a series of separation processes, including vacuum distillation), other heavy oil feedstocks, deasphalted heavy oil, and/or a conditioned heavy oil feedstock that includes a catalyst precursor and/or dispersed catalyst.

“Medium boiling hydrocarbon material” and “medium boiling hydrocarbon” refer to hydrocarbons at a processing facility that have a nominal boiling point in range of about 200° C. to about 524° C. Examples include, but are not limited to, vacuum gas oil (which typically has a boiling range of 360-524° C.), atmospheric gas oil (which typically has a boiling range of 200°-360° C.), decant oil or cycle oil (which typically has a boiling range of 360°−550° C.), fluid catalytic cracking (FCC)-derived oil, slurry oil, waste motor oil, or other hydrocarbons having a nominal boiling point in a range of about 200° C. to 524° C.

“Hydrocracking” and “hydroconversion” refer to processes whose primary purpose is to reduce the boiling range of heavy oil and in which a substantial portion of the heavy oil is converted into products with boiling ranges lower than that of the original feed. Hydrocracking or hydroconversion generally involves fragmentation of larger hydrocarbon molecules into smaller molecular fragments having a smaller number of carbon atoms and a higher hydrogen-to-carbon ratio. The mechanism by which hydrocracking occurs typically involves the formation of hydrocarbon free radicals during thermal fragmentation, followed by capping of free radicals with hydrogen. The hydrogen atoms or radicals that react with hydrocarbon free radicals during hydrocracking can be generated at or by active catalyst sites.

“Hydrotreating” refers to processes whose primary purpose is to remove impurities such as sulfur, nitrogen, oxygen, halides, and trace metals from the feedstock and saturate olefins and/or stabilize hydrocarbon free radicals by reacting them with hydrogen rather than allowing them to react with themselves. The primary purpose is not to change the boiling range of the feedstock. Hydrotreating is most often carried out using a fixed bed reactor, although other hydroprocessing reactors can be used, examples of which are an ebullated bed hydrotreater and slurry phase hydrotreater.

“Hydrocracking” and “hydroconversion” may also involve the removal of sulfur and nitrogen from a feedstock as well as olefin saturation and other reactions typically associated with “hydrotreating”. The terms “hydroprocessing” and “hydroconversion” shall broadly refer to both “hydrocracking” and “hydrotreating” processes, which define opposite ends of a spectrum, and everything in between along the spectrum.

“Hydrocracking reactor” refers to any vessel in which hydrocracking (i.e., reducing the boiling range) of a feedstock in the presence of hydrogen and a hydrocracking catalyst is the primary purpose. Hydrocracking reactors are characterized as having one or more inlet ports into which heavy oil and hydrogen are introduced, an outlet port from which an upgraded feedstock or material is withdrawn, and sufficient thermal energy that promotes fragmentation of larger hydrocarbon molecules into smaller molecules, causing formation of hydrocarbon free radicals. Examples of hydrocracking reactors include, but are not limited to, slurry phase reactors (i.e., two-phase, gas-liquid system), ebullated bed reactors (i.e., three-phase, gas-liquid-solid system), and fixed bed reactors (i.e., three-phase system that includes a liquid feed trickling downward over or flowing upward through a fixed bed of solid heterogeneous catalyst with hydrogen typically flowing co-currently with, but possibly counter-currently, to the heavy oil).

“Hydrocracking temperature” refers to a minimum temperature required to cause significant hydrocracking of a heavy oil feedstock. In general, hydrocracking temperatures will preferably fall within a range of about 399° C. (750° F.) to about 460° C. (860° F.), more preferably in a range of about 418° C. (785° F.) to about 443° C. (830° F.), and most preferably in a range of about 421° C. (790° F.) to about 440° C. (825° F.).

“Gas-liquid slurry phase hydrocracking reactor” refers to a hydroprocessing reactor that includes a continuous liquid phase and a gaseous dispersed phase, which forms a “slurry” of gaseous bubbles within the liquid phase. The liquid phase typically comprises a hydrocarbon feedstock that may contain a low concentration of dispersed metal sulfide catalyst particles, which can behave colloidally or as a pseudo solute, and the gaseous phase typically comprises hydrogen gas, hydrogen sulfide, and vaporized low boiling point hydrocarbon products. The liquid phase can optionally include a hydrogen donor solvent.

“Gas-liquid-solid, 3-phase slurry hydrocracking reactor” is used when a solid catalyst is employed along with liquid and gas. The gas may contain hydrogen, hydrogen sulfide, and vaporized low boiling hydrocarbon products. The term “slurry phase reactor” shall broadly refer to both types of reactors (e.g., those with dispersed metal sulfide catalyst particles, those with a micron-sized or larger particulate catalyst, and those that include both).

“Solid heterogeneous catalyst”, “heterogeneous catalyst” and “supported catalyst” refer to catalysts typically used in ebullated bed and fixed bed hydroprocessing systems, including catalysts designed primarily for hydrocracking, hydroconversion, hydrodemetallization, and/or hydrotreating. A heterogeneous catalyst typically comprises a catalyst support structure having a large surface area and interconnected channels or pores and fine active catalyst particles, such as sulfides of molybdenum, nickel, cobalt, vanadium, tungsten, and/or iron, dispersed within the channels or pores. The pores of the support are typically of limited size to maintain mechanical integrity of the heterogeneous catalyst and prevent breakdown and formation of excessive fines in the reactor. Heterogeneous catalysts can be produced as cylindrical pellets, cylindrical extrudates, other shapes such as trilobes, rings, saddles, or the like, or spherical solids.

“Upgrade”, “upgrading” and “upgraded”, when used to describe a hydrocarbon feedstock that is being or has been subjected to hydroprocessing, or a resulting material or product, refer to one or more of a reduction in molecular weight of the feedstock, a reduction in boiling point range of the feedstock, a reduction in concentration of asphaltenes, a reduction in concentration of hydrocarbon free radicals, and/or a reduction in quantity of impurities, such as sulfur, nitrogen, oxygen, halides, and metals.

“Severity” refers to the amount of energy that is introduced into heavy oil during hydroprocessing and is related to the operating temperature of the hydroprocessing reactor (i.e., higher temperature is related to higher severity and lower temperature is related to lower severity at same or similar throughput) in combination with duration or residence time (which are inversely proportional to throughput). Increased severity generally increases the quantity of converted products produced by the hydroprocessing reactor, including both desirable products and undesirable products. Conversion and throughput also affect severity. For example, when temperature is increased and throughput is held constant, conversion typically increases for a given feedstock. In order to maintain temperature while increasing throughput (i.e., increasing the liquid hourly space velocity), which decreases residence time of the heavy oil in the reactor, more heat energy must be added to the system to offset the cooling effect of passing a greater quantity per unit time of initially cooler heavy oil into the reactor.

Desirable conversion products include hydrocarbons of reduced molecular weight, boiling point, and specific gravity, which can include end products such as naphtha, diesel, jet fuel, kerosene, wax, fuel oil, and the like. Other desirable conversion products include higher boiling hydrocarbons that can be further processed using conventional refining and/or distillation processes. Bottoms products of sufficient quality to be useful as fuel oil are other examples of desirable conversion products.

Undesirable conversion products include coke, sediment, metals, and other solid materials that can deposit on hydroprocessing equipment and cause fouling, such as interior components of reactors, separators, filters, pipes, towers, heat exchangers, and the heterogeneous catalyst. Low quality conversion products can refer to unconverted resid that remains after distillation, such as atmospheric tower bottoms (“ATB”) or vacuum tower bottoms (“VTB”), particularly which are of too low of quality to be useful as fuel oil or other desired use. Minimizing undesirable conversion products reduces equipment fouling and shutdowns required to clean the equipment.

In addition to temperature, “severity” can be related to one or both of “conversion” and “throughput”. Whether increased severity involves increased conversion and/or increased or decreased throughput may depend on the quality of the heavy oil feedstock and/or the mass balance of the overall hydroprocessing system. For example, where it is desired to convert a greater quantity of feed material and/or provide a greater quantity of material to downstream equipment, increased severity may primarily involve increased throughput without necessarily increasing fractional conversion. This can include the case where resid fractions (ATB and/or VTB) are sold as fuel oil, and increased conversion without increased throughput might decrease the quantity of this product. In the case where it is desired to increase the ratio of upgraded materials to resid fractions, it may be desirable to primarily increase conversion without necessarily increasing throughput. Where the quality of heavy oil introduced into the hydroprocessing reactor fluctuates, it may be desirable to selectively increase or decrease one or both of conversion and throughput to maintain a desired ratio of upgraded materials to resid fractions and/or a desired absolute quantity or quantities of end product(s) being produced.

For feedstocks other than heavy oil, the term “conversion” means the feedstock material or component is converted to a more desirable product (or products). For heavy oil, “conversion” and “fractional conversion” refer to the proportion, often expressed as a percentage, of heavy oil that is converted into lower boiling and/or lower molecular weight materials. Conversion is expressed as a percentage of the initial resid content (i.e., components with boiling points greater than a defined residue cut point) that is converted to products with boiling points less than the defined cut point. The definition of residue cut point can vary and can nominally include 524° C. (975° F.), 538° C. (1000° F.), 565° C. (1050° F.), and the like. It can be measured by distillation analysis of feed and product streams to determine the concentration of components with boiling point greater than the defined cut point. Fractional conversion is expressed as (F−P)/F, where F is the quantity of resid in the combined feed streams and P is the quantity in the combined product streams, where both feed and product resid content are based on the same cut point definition. The quantity of resid is most often defined based on the mass of components with boiling point greater than the defined cut point, but volumetric or molar definitions can also be used.

The conversion of asphaltenes can be different than the overall conversion of heavy oil. For purposes of this disclosure, a useful definition of asphaltene conversion is based on the relative amounts of asphaltenes in the fresh feedstock and upgraded product, and can be defined by the following, which results in a decimal fraction between 0 and 1, which can be converted into a percentage by multiplying by 100:

Conv=[Asph(fresh feed)−Asph(products)]/Asph(fresh feed).

The asphaltene content of a recycle stream is internal to the process. When conversion of asphaltenes is too low compared to conversion of heavy oil as a whole, recycle buildup of asphaltenes can occur.

“Throughput” refers to the quantity (mass or volume) of feed material introduced into the hydroprocessing reactor per unit of time. Throughput can be expressed in volumetric terms, such as barrels per hour or per day, or in mass terms, such as metric tons per hour or per day. In common usage, throughput is defined as the mass or volumetric feed rate of only the heavy oil feedstock itself (for example, vacuum tower bottoms or the like). The definition normally excludes the quantity of diluents or other components that can be added to or included in the overall feeds to a hydroconversion unit, although a definition which includes those other components can also be used.

“Space velocity” and “liquid hourly space velocity” are related to the throughput of a particular reactor or reactor size but are normalized to remove the size (volume) of the reactor. Thus, a larger reactor can have twice the throughput but the same space velocity as a reactor with half the volume size. Therefore, an increase in space velocity is typically proportional to an increase in throughput for a given reactor size. Space velocity is inversely proportional to residence time of heavy oil in a reactor of given reactor size. “Longer space velocity” means higher residence time and reduced throughput.

“Production rate of converted products” is an absolute rate that can be expressed in volumetric terms, such as barrels per hour or per day, or in mass terms, such as metric tons per hour or per day. The “production rate of converted products” should not be confused with yield or efficiency, which are sometimes erroneously called “rate” (e.g., production rate per unit feed rate, or production rate per unit converted feed). It will be appreciated that the actual numeric values of both initial production rate of converted products and increased production rate of converted products are specific to an individual production facility and depend on the capacity of that facility. Therefore, it is valid to compare the production rate of the unit or facility in question before and after modification but not against a different unit or facility built with a different capacity.

“Fouling” refers to the formation of an undesirable phase (foulant) that interferes with processing. The foulant is normally a carbonaceous material or solid (e.g., sediment) that deposits and collects within the processing equipment. Equipment fouling can result in loss of production due to equipment shutdown, decreased performance of equipment, increased energy consumption due to the insulating effect of foulant deposits in heat exchangers or heaters, increased maintenance costs for equipment cleaning, reduced efficiency of fractionators, and reduced reactivity of the heterogeneous catalyst. Hydroprocessing equipment, such as mixing lines, require periodic maintenance to remove sediment and other foulants.

“Rate of equipment fouling” of a hydrocracking reactor can be determined by at least one of: (i) frequency of required heat exchanger clean-outs; (ii) frequency of switching to spare heat exchangers; (iii) frequency of filter changes; (iv) frequency of strainer clean-outs or changes; (v) rate of decrease in equipment skin temperatures, including in equipment selected from heat exchangers, separators, or distillation towers; (vi) rate of increase in furnace tube metal temperatures; (vii) rate of increase in calculated fouling resistance factors for heat exchangers and furnaces; (viii) rate of increase in differential pressure of heat exchangers; (ix) frequency of cleaning atmospheric and/or vacuum distillation towers; or (x) frequency of maintenance turnarounds.

### C. Other Definitions

“Catalyst precursor” and “dispersed catalyst precursor” refer to a compound, such as an oil-soluble organometallic compound, which contains or provides one or more catalyst metals, such as molybdenum, nickel, cobalt, vanadium, tungsten, and/or iron. The catalyst precursor can be oil-soluble and have a decomposition temperature in a range from about 100° C. to about 350° C., or in a range of about 150° C. to about 300° C., or in a range of about 175° C. to about 250° C. Example catalyst precursors include organometallic complexes or compounds, more specifically oil soluble compounds or complexes of transition metals and organic acids, having a decomposition temperature or range high enough to avoid substantial decomposition when mixed with hydrocarbon feedstock materials under suitable mixing conditions. When mixing the catalyst precursor with a carrier oil, it is advantageous to maintain the carrier oil at a temperature below which significant decomposition of the catalyst precursor occurs. One skilled in the art can select a mixing temperature profile that results in intimate mixing of a selected catalyst precursor without substantial decomposition prior to forming dispersed metal sulfide catalyst particles in situ.

Example catalyst precursors include, but are not limited to, molybdenum 2-ethylhexanoate, nickel 2-ethylhexanoate, cobalt 2-ethylhexanoate, tungsten 2-ethylhexanoate, molybdenum octoate, molybdenum naphthenate, molybdenum dithiocarbamate, molybdenum diothiophosphate, molybdenum diothiophosphinate, vanadium naphthenate, vanadium octoate, molybdenum hexacarbonyl, vanadium hexacarbonyl, and iron pentacarbonyl. Other catalyst precursors include transition metal salts comprising a plurality of transition metal cations (e.g., molybdenum, nickel, cobalt, vanadium, tungsten, and/or iron cations) and a plurality of organic anions, such as carboxylates and derivatives having at least 8 carbon atoms and that are at least one of (a) aromatic, (b) alicyclic, or (c) branched, unsaturated and aliphatic. By way of example, each carboxylate or derivative anion may have between 8 and 17 carbon atoms or between 11 and 15 carbon atoms.

Examples of carboxylate anions that fit at least one of the foregoing categories include carboxylate anions derived from carboxylic acids selected from the group consisting of 3-cyclopentylpropionic acid, cyclohexanebutyric acid, biphenyl-2-carboxylic acid, 4-heptylbenzoic acid, 5-phenylvaleric acid, geranic acid (3,7-dimethyl-2,6-octadienoic acid), 10-undecenoic acid, dodecanoic acid, and combinations thereof. It has been discovered that transition metal (e.g., molybdenum, nickel, cobalt, vanadium, tungsten, and/or iron) catalyst precursors made using carboxylate anions derived from the foregoing carboxylic acids possess improved thermal stability.

Catalyst precursors with higher thermal stability can have a first decomposition temperature higher than 210° C., higher than about 225° C., higher than about 230° C., higher than about 240° C., higher than about 275° C., or higher than about 290° C. Such catalyst precursors can have a peak decomposition temperature higher than 250° C., or higher than about 260° C., or higher than about 270° C., or higher than about 280° C., or higher than about 290° C., or higher than about 330° C. The catalyst precursor may be selected based on the temperature of the materials being mixed, with a catalyst precursor having a higher decomposition temperature being preferred at higher mixing temperatures to prevent premature thermal decomposition.

“Diluted precursor mixture” refers to a mixture of a hydrocarbon carrier oil and catalyst precursor, which is used to disperse the catalyst precursor into a heavy oil feedstock. The carrier oil can be a conventional petroleum-derived diluent and/or a nonpetroleum-derived material. Example petroleum-derived carrier oils include atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C. Example nonpetroleum-derived carrier oils include any of the nonpetroleum-derived materials listed above. However, in order to avoid premature thermal decomposition of the catalyst precursor when forming the diluted precursor mixture, at least a portion of the nonpetroleum-derived carrier oil should be a liquid at a temperature below the decomposition temperature of the catalyst precursor. In the case of initially solid nonpetroleum-derived materials, it may be necessary to treat them by one or more of pyrolysis (to form pyrolysis oil), forming a mixture with a carrier oil solvent, melting them (e.g., in the case of a polymer) as long as the melting point is less than the decomposition temperature of the catalyst precursor, or comminuting them to a particle size of about 50 mesh (about 300 μm) or smaller, or about 70 mesh (about 210 μm) or smaller, or about 100 mesh (about 150 μm) or smaller, and dispersing or dissolving the particles in another liquid carrier oil.

“Dispersed metal sulfide catalyst particles” and “dispersed catalyst” refer to catalyst particles having a particle size below 1 μm (submicron, or sub micrometer), preferably less than about 500 nm, or less than about 250 nm, or less than about 100 nm, or less than about 50 nm, or less than about 25 nm, or less than about 10 nm, or less than about 5 nm. The term “dispersed metal sulfide catalyst particles” may include molecular or molecularly dispersed catalyst compounds. “Dispersed metal sulfide catalyst particles” typically excludes metal sulfide particles and agglomerates of metal sulfide particles that are larger than 1 μm.

“Molecularly dispersed catalyst” refers to catalyst compounds that are essentially “dissolved” or dissociated from other catalyst compounds or molecules in a hydrocarbon feedstock or suitable diluent. It can include very small catalyst particles that contain a few catalyst molecules joined together (e.g., 15 molecules or less).

“Conditioned feedstock” refers to a hydrocarbon feedstock into which a catalyst precursor has been combined and mixed sufficiently so that, upon decomposition of the catalyst precursor and formation of the active catalyst, the catalyst will comprise dispersed metal sulfide catalyst particles formed in situ within the feedstock.

“Residual dispersed catalyst particles” and “residual dispersed metal sulfide catalyst particles” refer to catalyst particles that remain with a hydrocarbon product when transferred from one vessel to another (e.g., from a hydroprocessing reactor to a separator and/or other hydroprocessing reactor). Residual dispersed metal sulfide catalyst particles may also remain in a liquid residual fraction or pitch after separation of a hydrocarbon product into distillates and residual liquid or pitch, such as by flash separation, hot separation, atmospheric distillation, vacuum distillation, or vacuum stripping.

### III. Methods and Systems for Mixing Catalyst Precursors into Hydrocarbon Feedstocks to Form Conditioned Feedstocks

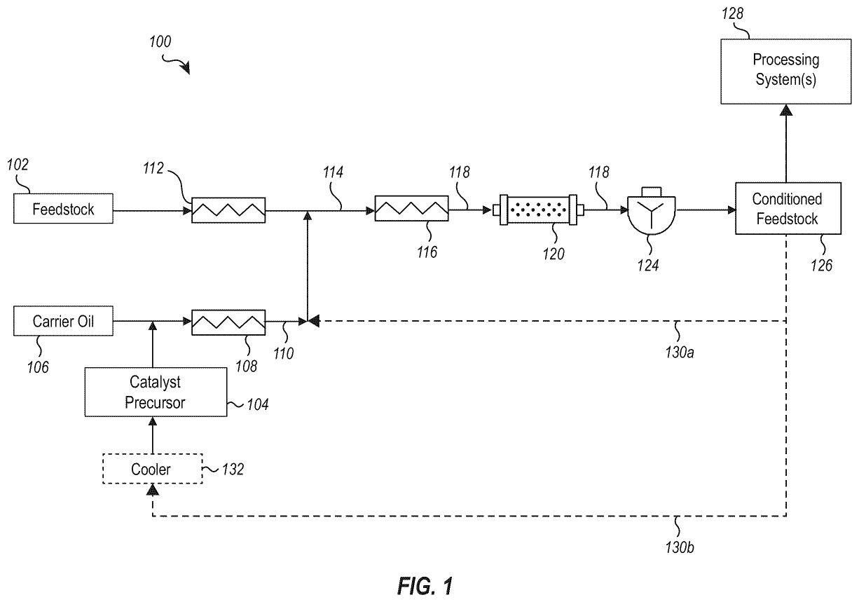

FIG. 1 schematically illustrates an example mixing system 100 and corresponding method for dispersing a catalyst precursor 104 into a hydrocarbon feedstock material 102 to form a conditioned hydrocarbon feedstock 126, which can be used for subsequent processing.

For simplicity, FIG. 1 illustrates an embodiment where there is a single hydrocarbon feedstock 102. Mixing system 100 includes feedlines for each of the hydrocarbon feedstock material 102, the catalyst precursor 104, and the hydrocarbon carrier oil 106. The catalyst precursor 104 is combined and mixed with the hydrocarbon carrier oil 106 by one or more static inline mixers 108 to form a diluted precursor mixture 110, which is combined with the hydrocarbon feedstock material 102 and then mixed to form the conditioned feedstock 126. Prior to being mixed with the diluted precursor mixture 110, the hydrocarbon feedstock material 102 can be optionally premixed by optional static inline mixer 112. Such premixing can be beneficial in cases where the feedstock materials are themselves a mixture of dissimilar materials and/or which are multi-phase so as to have liquid and solid components.

The hydrocarbon carrier oil 106 used to form the diluted precursor mixture 110 may include a petroleum-derived hydrocarbon and/or a nonpetroleum-derived hydrocarbon. Examples of petroleum-derived carrier oils include, but are not limited to, atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C. Examples of nonpetroleum-derived carrier oils include, but are not limited to, biomass-derived materials, used cooking oil and other fats, plastics and polymers, fabrics and textiles, paper and cardboard, rubber, waste products, and pyrolysis products of the foregoing (particularly in the case where the material is not a liquid at the processing temperature used to form the diluted precursor mixture 110).

The feedstock material 102 and diluted precursor mixture 114 are combined into a combined feedstream 114 prior to mixing. The combined feedstream 114 is initially mixed by one or more static inline mixers 116 to form an intermediate blend 118, which can be passed through optional strainer 120 to form an optionally strained intermediate blend 122. The optionally strained intermediate blend 122 is then mixed by one or more high shear mixers 124 to form a conditioned hydrocarbon feedstock 126. The conditioned hydrocarbon feedstock 126 can be further processed by downstream processing system(s) 128.

A side stream 130 of the conditioned hydrocarbon feedstock 126 can optionally be recycled and combined with the hydrocarbon feedstock material 102 and/or the diluted precursor mixture 110, such as by being added to the diluted precursor mixture 110 and/or by providing all or a portion of the carrier oil 106 used to form the diluted precursor mixture 110. When used as the carrier oil 106, a cooler 132 can be used to reduce the temperature of the side stream 130 of the conditioned hydrocarbon feedstock 126 to prevent premature thermal decomposition of the catalyst precursor 104 in the diluted precursor mixture 110 prior to being thoroughly mixed with the hydrocarbon feedstock material 102. When used as all or part of the carrier oil 106, the side stream 130 of the conditioned hydrocarbon feedstock 126 can be cooled to a temperature of about 75° C. to about 150° C., preferably about 75° C. to about 125° C., and more preferably about 75° C. to about 95° C. In some embodiments, at least a portion of the cooling can be provided by a lower boiling hydrocarbon carrier oil 106 (e.g., vacuum gas oil or cycle oil) that is already at a temperature below the decomposition temperature of the catalyst precursor 104.

In principle, the hydrocarbon feedstock 102 and the carrier oil 106 can be selected from any of the categories and types of hydrocarbon feedstock sources discussed herein. In some cases, components within the hydrocarbon feedstock material 102 and/or the carrier oil 106 may exhibit some degree of incompatibility or difficulty in mixing. Typically, at least a portion of the hydrocarbon feedstock 102 and/or the carrier oil 106 will be an “unconventional” type of hydrocarbon material (e.g., nonpetroleum-derived), such as one or more of biomass-derived materials, nonpetroleum-derived oils or fats, polymers, fabrics or textiles, paper or cardboard, rubber, waste products, pyrolysis products of the foregoing, or combinations thereof. In some embodiments, the hydrocarbon feedstock 102 and/or the carrier oil 106 may comprise petroleum-derived materials, such as higher boiling heavy oils and/or lower boiling hydrocarbon diluents discussed herein.

An example method for dispersing a catalyst precursor into a hydrocarbon feedstock to form a conditioned hydrocarbon feedstock containing at least one nonpetroleum-derived hydrocarbon material for subsequent processing using the mixing system 100 illustrated in FIG. 1 comprises:
(1) mixing a catalyst precursor with a hydrocarbon carrier oil by one or more static inline mixers to form a diluted precursor mixture; and
(2) blending the diluted precursor mixture with a hydrocarbon feedstock material by one or more static inline mixers and one or more high shear mixers to form the conditioned hydrocarbon feedstock;
(3) wherein the hydrocarbon carrier oil, the primary hydrocarbon feedstock material, and the optional secondary hydrocarbon feedstock material are independently selected from the group consisting of biomass-derived material, nonpetroleum-derived oil or fat, polymer, fabric or textile, paper or cardboard, rubber, waste product, pyrolysis product of one or more of the foregoing, petroleum-derived material, and combinations thereof, and
(4) wherein at least one of the hydrocarbon carrier oil, the primary hydrocarbon feedstock material, or the optional secondary hydrocarbon feedstock material comprises a nonpetroleum-derived hydrocarbon material.

In general, systems for dispersing a catalyst precursor into a hydrocarbon feedstock to form a conditioned hydrocarbon feedstock containing at least one nonpetroleum-derived hydrocarbon material for subsequent processing using the illustrated method associated with FIG. 1 comprise means (e.g., apparatus configured) for performing the steps recited in the preceding paragraph.

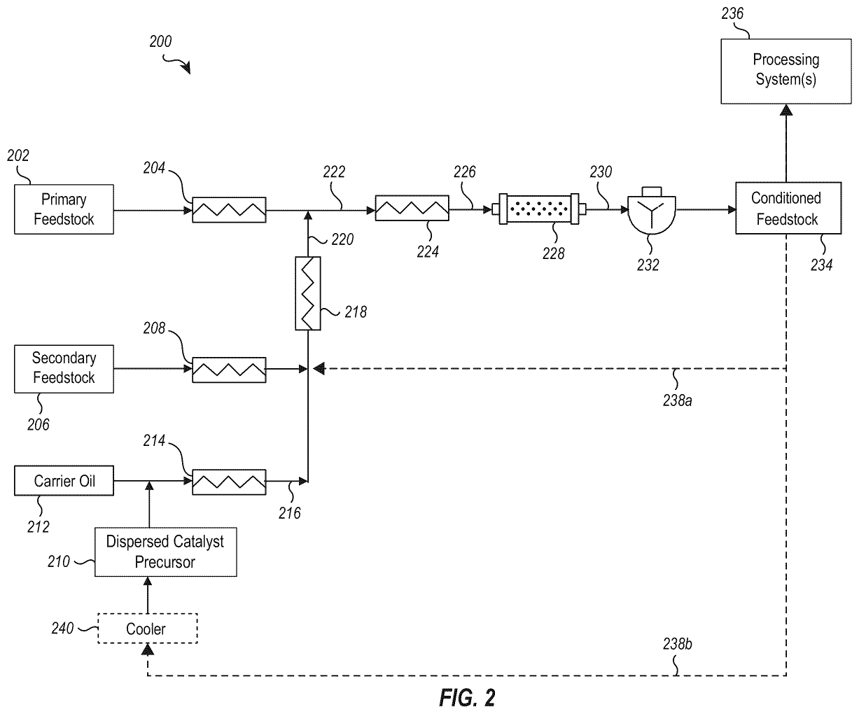

As noted above, some embodiments of the invention may include more than one hydrocarbon feedstock material. FIG. 2 more particularly illustrates an example mixing system 200 and corresponding method for mixing two different hydrocarbon feedstock materials with a diluted precursor mixture to form a conditioned hydrocarbon feedstock, which can be used for subsequent processing.

As schematically illustrated in FIG. 2, the mixing system 200 illustrates an example configuration and corresponding method for combining a primary hydrocarbon feedstock material 202 (e.g., petroleum-derived), a secondary hydrocarbon feedstock material 206 (e.g., nonpetroleum-derived), and a catalyst precursor 210 pre-mixed with a carrier oil 212 to form a diluted precursor mixture 216, which are mixed together to form conditioned hydrocarbon feedstocks for subsequent processing. The mixing system 200 includes feedlines for each of the primary hydrocarbon feedstock material 202, the secondary hydrocarbon feedstock material 206, the catalyst precursor 210, and the carrier oil 212. In this embodiment, prior to being mixed with other hydrocarbon feedstock materials, the primary hydrocarbon feedstock material 202 can be optionally premixed by optional static inline mixer 204, and the secondary hydrocarbon feedstock material 206 can be optionally premixed by optional static inline mixer 208. Such pre-mixing may be beneficial in cases where the feedstock materials are a mixture of dissimilar materials and/or which are multi-phase so as to have liquid and solid components.

FIG. 2 further shows the catalyst precursor 210 and the carrier oil 212 being mixed by a static inline mixer 214 to form a diluted precursor mixture 216. The carrier oil can be petroleum-derived or nonpetroleum-derived. The hydrocarbon carrier oil 212 used to form the diluted precursor mixture 216 may include a petroleum-derived hydrocarbon and/or a nonpetroleum-derived hydrocarbon. Examples of petroleum-derived carrier oils include, but are not limited to, atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C. Examples of nonpetroleum-derived carrier oils include, but are not limited to, biomass-derived materials, used cooking oil and other fats, plastics and polymers, fabrics and textiles, paper and cardboard, rubber, waste products, and pyrolysis products of the foregoing (particularly in the case where the material is not a liquid at the processing temperature used to form the diluted precursor mixture 216).

The diluted precursor mixture 216 and the secondary hydrocarbon feedstock material 206 can be combined to form a partial feedstream 220, which is combined with the primary hydrocarbon feedstock material 202 to form a combined feedstream 222 prior to mixing. An optional static inline mixture 218 can be used to premix the partial feedstream 220 to disperse the diluted precursor mixture 216 with the secondary hydrocarbon feedstock material 206. Alternatively, the diluted precursor mixture 216 can be premixed with the primary hydrocarbon feedstock material 202 to form a partial feedstream (not shown) prior to mixing with the secondary hydrocarbon feedstock material 206. Premixing the diluted precursor mixture 216 with the primary and/or secondary hydrocarbon feedstock materials 202, 206 can be beneficial to ensure more thorough mixing of the catalyst precursor 210 within the conditioned hydrocarbon feedstock 234.

The primary hydrocarbon feedstock material 202, the secondary hydrocarbon feedstock material 206, and the diluted precursor mixture 216 are combined into feedstream 222 prior to mixing. The combined feedstream 222 is initially mixed by one or more static inline mixers 224 to form an intermediate blend 226, which can be passed through optional strainer 228 to form optionally strained intermediate blend 230. The optionally strained intermediate blend 230 is then mixed by one or more high shear mixers 232 to form a well-mixed conditioned hydrocarbon feedstock 234. The conditioned hydrocarbon feedstock 234 can be further processed by downstream processing system(s) 236. A portion of the conditioned hydrocarbon feedstock 234 can optionally be recycled and combined with the primary hydrocarbon feedstock material 202, the secondary hydrocarbon feedstock material 206, and the diluted precursor mixture 216. Such recycling may be desirable to effect more complete mixing, particularly if the primary and secondary feedstock materials 202, 206 are particularly difficult to blend, to maintain desired flow rates in various parts of the system, to ensure even more thorough dispersion of the catalyst precursor 210 into the conditioned hydrocarbon feedstock 234, and the like.

An example method for dispersing a catalyst precursor into a multiple hydrocarbon feedstocks to form a conditioned hydrocarbon feedstock containing at least one nonpetroleum-derived hydrocarbon material for subsequent processing using the mixing system 200 illustrated in FIG. 2 comprises:
(1) mixing a catalyst precursor with a hydrocarbon carrier oil by one or more static inline mixers to form a diluted precursor mixture;
(2) optionally combining the diluted precursor mixture with a primary and/or a secondary hydrocarbon feedstock material to form a partial feedstream and premixing the partial feedstream by means of a static inline mixer;
(3) mixing the primary hydrocarbon feedstock material, the secondary hydrocarbon feedstock material, and the diluted precursor mixture by one or more static inline mixers to form an intermediate blend, and optionally straining the intermediate blend to form a strained intermediate blend;
(4) further mixing the optionally straining intermediate blend by one or more high shear mixers to form the conditioned hydrocarbon feedstock; and
(5) optionally recycling a portion of the conditioned hydrocarbon feedstock by combining the recycled portion with the primary hydrocarbon feedstock material, secondary hydrocarbon feedstock material, and/or diluted precursor mixture,
(6) wherein the hydrocarbon carrier oil, the primary hydrocarbon feedstock material, and the secondary hydrocarbon feedstock material are independently selected from the group consisting of biomass-derived material, nonpetroleum-derived oil or fat, polymer, fabric or textile, paper or cardboard, rubber, waste product, pyrolysis product of one or more of the foregoing, petroleum-derived material, and combinations thereof, and
(7) wherein at least one of the hydrocarbon carrier oil, the primary hydrocarbon feedstock material, or the secondary hydrocarbon feedstock material comprises a nonpetroleum-derived hydrocarbon material.

In general, systems for dispersing a catalyst precursor into a plurality of hydrocarbon feedstock materials to form a conditioned hydrocarbon feedstock containing at least one nonpetroleum-derived hydrocarbon material for subsequent processing using the illustrated method associated with FIG. 2 comprise means (e.g., apparatus configured) for performing the steps recited in the preceding paragraph.

In some embodiments, the primary hydrocarbon feedstock material comprises at least one petroleum-derived material selected from the group consisting of vacuum residue (straight-run or product from hydrocracking or hydroconversion process), vacuum gas oil (straight-run or product from hydrocracking or hydroconversion process), atmospheric residue, atmospheric gas oil, bitumen, visbreaker bottoms, resid pitch, heavy oil, deasphalted heavy oil, fluid catalytic cracking (FCC)-derived oil, slurry oil, cycle oil (light cycle oil or heavy cycle oil), decant oil, petroleum-based pyrolysis oil, waste motor oil, and combinations thereof.

In the case where the primary hydrocarbon feedstock material comprises or consists of at least one petroleum-derived material, the secondary hydrocarbon feedstock material may advantageously comprise at least one nonpetroleum-derived hydrocarbon material selected from the group consisting of biomass-derived material, nonpetroleum-derived oil or fat, polymer, fabric or textile, paper or cardboard, rubber, waste product, pyrolysis product of one or more of the foregoing, and combinations thereof.

For any of the above process configurations, the high-shear mixer can be a commercially available high intensity mixing device, such as those supplied by Silverson Machines, Inc., located in Waterside, England, and IKA Works, Inc., located in Wilmington, North Carolina, United States. High shear mixers typically include a vessel with a propeller or turbine impeller for providing very turbulent, high shear mixing.

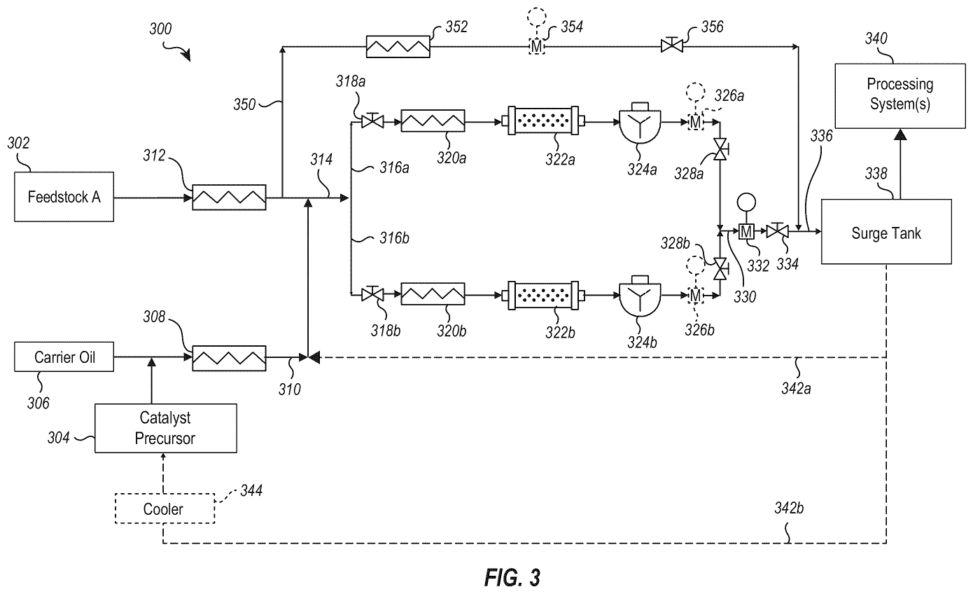

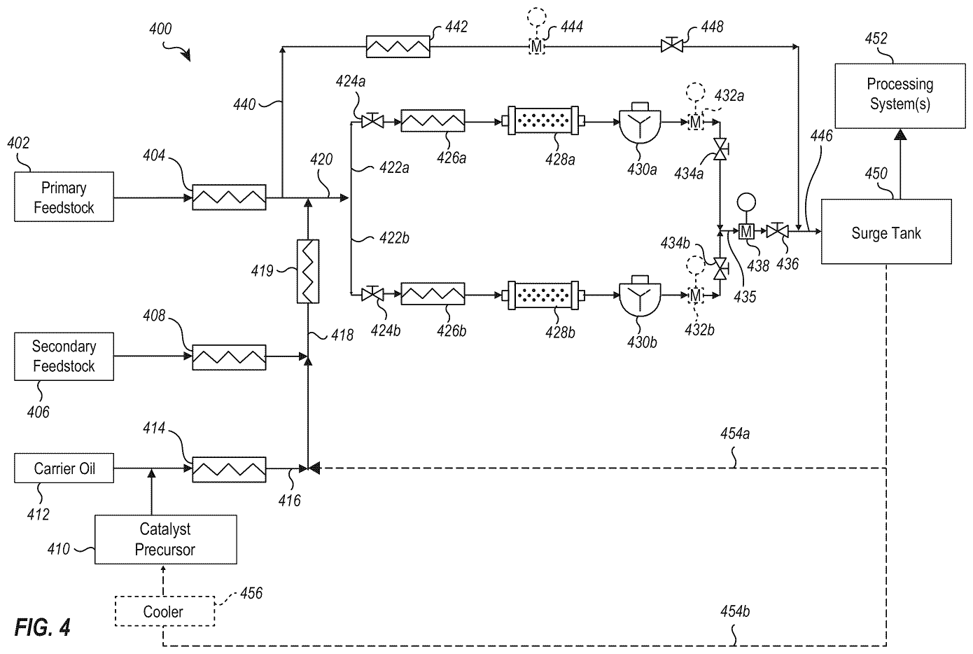

While FIGS. 1 and 2 each show a mixing configuration with a single mixing line, this invention can also utilize mixing configurations disclosed in U.S. Pub. No. 2023/0383198, which is incorporated by reference in its entirety. FIGS. 3 and 4 schematically illustrate example mixing systems that incorporate a plurality of (e.g., two) mixing lines and a recirculation line in case a mixing line needs to be taken offline for maintenance.

FIG. 3 more particularly illustrates a mixing system 300 and corresponding method having two parallel mixing lines configured to mix together a hydrocarbon feedstock material and a catalyst precursor to form a conditioned hydrocarbon feedstock 336 for subsequent processing. The mixing system 300 includes feedlines for each of a hydrocarbon feedstock material 302, a dispersed catalyst precursor 304, and a hydrocarbon carrier oil 306. In this embodiment, prior to being mixed with a diluted precursor mixture 310 the hydrocarbon feedstock material 302 can be optionally premixed by optional static inline mixer 312. Such premixing may be beneficial in cases where the feedstock material is a mixture of dissimilar materials and/or which are multi-phase so as to have liquid and solid components.

FIG. 3 further shows the dispersed catalyst precursor 304 and the hydrocarbon carrier oil 306 being mixed by a static inline mixer 308 to form a diluted precursor mixture 310. The hydrocarbon carrier oil 306 used to form the diluted precursor mixture 310 may include a petroleum-derived hydrocarbon and/or a nonpetroleum-derived hydrocarbon. Examples of petroleum-derived carrier oils include, but are not limited to, atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C. Examples of nonpetroleum-derived carrier oils include, but are not limited to, biomass-derived materials, used cooking oil and other fats, plastics and polymers, fabrics and textiles, paper and cardboard, rubber, waste products, and pyrolysis products of the foregoing (particularly in the case where the material is not a liquid at the processing temperature used to form the diluted precursor mixture 310).

The hydrocarbon feedstock material 302 and the diluted precursor mixture 310 are combined into feedstream 314 prior to mixing. The combined feedstream 314 is split between first and second parallel mixing lines 316a, 316b. Each mixing line 316a, 316b may include an upstream valve 318a, 318b, which can be selectively opened during operation of the mixing lines 316a, 316b and closed to take a mixing line 316 offline (e.g., for maintenance and cleaning). When the first and second parallel mixing lines 316a, 316b are both online, the upstream valves 318a, 318b are open to permit the divided streams of the combined feedstream 314 to flow through the first and second mixing lines 316a, 316b. One of the upstream valves 318a, 318b can be closed to take one of the mixing lines 316a, 316b offline. In a preferred embodiment, the first and second parallel mixing lines 316a, 316b are designed with symmetrical piping and mixing equipment so that the pressure drop is substantially equal through each parallel mixing line 316a, 316b, and equal flow between the mixing lines 316a, 316b can be maintained. Nevertheless, mixing lines 316a, 316b of different capacity and flow can be used, such as when retrofitting a single train mixing line to include one or more additional mixing lines. It will be appreciated that one or more additional mixing lines (not shown) can be utilized if desired to further increase the capacity of the mixing system 300.

The divided streams of the combined feedstream 314 are initially mixed by first and second static inline mixers 320a, 320b to produce first and second initial mixed streams, which can pass through optional first and second strainers 322a, 322b to remove any undesirable solids in the initial mixed streams. The first and second optionally strained mixed streams are further mixed by first and second high shear mixers 324a, 324b, which provide first and second blended hydrocarbon feedstock streams. Optional first and second flow meters 326a, 326b can be provided to measure flow through the first and second parallel mixing lines 316a, 316b downstream from the first and second high shear mixers 324a, 324b.

The first and second parallel mixing lines 316a, 316b further include first and second flow control devices 328a, 328b positioned downstream from the high shear mixers 324a, 324b. The flow control devices 328a, 328b can provide multiple functions. When the first and second parallel mixing lines 316a, 316b are both online, the flow control devices 328a, 328b will be open. When one of the mixing lines 316 is taken offline, the corresponding flow control device 328 can be closed to prevent backup of pressurized blended feedstock from the other mixing line 316 still in operation. The flow control device 328 of the mixing line 316 that is still in operation can be open all the way or, alternatively, can be partially closed if necessary to restrict flow and increase upstream pressure to cause or allow a portion of the combined feedstream 314 to enter a bypass line 350.

The blended hydrocarbon feedstock streams from the first and second mixing lines 316a, 316b are fed into and combined in a common discharge line 330 to form a common conditioned hydrocarbon feedstock stream 336. The common conditioned hydrocarbon feedstock stream 336 passes through or past a common flow measurement device 332 (e.g., flow meter) and then through a common flow control device 334 (e.g., valve), is recombined with any hydrocarbon feedstock material from the bypass line 350, and enters a surge tank 338 to form a well-mixed conditioned hydrocarbon feedstock for subsequent processing. The conditioned hydrocarbon feedstock can be further processed by downstream processing system(s) 340.

A side stream 342 of the conditioned hydrocarbon feedstock from the surge tank 338 can optionally be recycled, such as by being added to the diluted precursor mixture 310 as shown, to the hydrocarbon feedstock material 302 (not shown), or the combined feedstream 314 and/or by providing all or a portion of the hydrocarbon carrier oil 306 used to form the diluted precursor mixture 310. When used as the hydrocarbon carrier oil 306, a cooler 344 can be used to reduce the temperature of the side stream 342 of the conditioned hydrocarbon feedstock to prevent premature thermal decomposition of the catalyst precursor 304 in the diluted precursor mixture 310 prior to being thoroughly mixed with the hydrocarbon feedstock material 302. When used as all or part of the carrier oil 306, the side stream 342 of the conditioned hydrocarbon feedstock can be cooled to a temperature of about 75° C. to about 150° C., preferably about 75° C. to about 125° C., and more preferably about 75° C. to about 95° C. In some embodiments, at least a portion of the cooling can be provided by a lower boiling hydrocarbon carrier oil 306 (e.g., vacuum gas oil or cycle oil) that is already at a temperature below the decomposition temperature of the catalyst precursor 304.

When both parallel mixing lines 316a, 316b are online and operational, the common flow control device 334 is open. When one of the mixing lines 316a, 316b is closed and taken offline, such as by closing one or more flow control valves 318, 328, the common flow control device 334 can be partially closed to restrict flow of material through the common discharge line 330 and increase upstream pressure to cause or allow a portion of the combined feedstream 314 and/or the hydrocarbon feedstock material 302 to enter the bypass line 350. The common flow control device 334 can be used alone or in combination with one of the flow control devices 328 corresponding to the mixing line 316 that is still in operation to control upstream pressure.

The bypass line 350 typically does not have hydrocarbon feedstock material flowing through it when both the first and second mixing lines 316a, 316b are online and in operation. However, when one of the parallel mixing lines 316a, 316b is closed and taken offline, the portion of hydrocarbon feedstock material not fed into the remaining online mixing line 316 is caused or allowed to pass through the bypass line 350 to maintain throughput of hydrocarbon feedstock materials through the mixing system 300. As discussed above, flow of hydrocarbon feedstock material though the bypass line 350 is caused or induced by restricting flow through the common discharge line 330 by partially closing common flow control valve 334 and/or the mixing line valve 328 of the operational mixing line 316. This induces a pressure drop and increases upstream pressure sufficient to cause a portion of hydrocarbon feedstock material to enter the bypass line 350.

The bypass line 350 can include an optional static inline mixer 352 to cause at least partial mixing of hydrocarbon feedstock material 302 and the diluted precursor mixture 310 that may enter the bypass line 350. The bypass line 350 can include an optional flow meter 354 to measure the flow rate of hydrocarbon feedstock material passing through the bypass line 350. The bypass line 350 can include a bypass line valve 356 to control the flow rate and/or pressure of hydrocarbon feedstock material passing through the bypass line 350. The bypass line 350 is joined to the common discharge line 330 to combine hydrocarbon feedstock material from the bypass line 350 with the common blended hydrocarbon feedstock stream 336 downstream from the flow control device 334 and flow meter 332.

The flow rates of hydrocarbon feedstock streams that are passed through the remaining operational mixing line 316 and the bypass line 350 can be measured, respectively, by the common flow meter 332 and the optional bypass flow meter 354. The respective flow rates of hydrocarbon feedstock material through the remaining operational mixing line 316 and the bypass line 350 can be adjusted by making adjustments to the common flow control valve 334 and/or the bypass line valve 356. By measuring flow rates using flow meters and making adjustments using flow control devices, a desired balance of flow through the various lines can be achieved and maintained. In addition to adjusting flow rate through the bypass line 350, the bypass line valve 356 can be closed or partially restricted to balance line pressure to ensure that hydrocarbon feedstock material does not pass through the bypass line 350, either in a forward or backward direction, when the first and second mixing lines 316a, 316b are open and operational.

An example method for dispersing a catalyst precursor into a hydrocarbon feedstock to form a conditioned hydrocarbon feedstock containing at least one nonpetroleum-derived hydrocarbon material for subsequent processing using the mixing system 300 illustrated in FIG. 3 comprises:
(1) mixing a catalyst precursor with a hydrocarbon carrier oil by one or more static inline mixers to form a diluted precursor mixture;
(2) mixing a hydrocarbon feedstock material and the diluted precursor mixture using a plurality of parallel mixing lines to form a plurality of conditioned hydrocarbon feedstock streams, each parallel mixing line including one or more static inline mixers, optionally a strainer, one or more high shear mixers, and at least one valve for regulating flow in the mixing line;
(3) combining the conditioned hydrocarbon feedstock streams in a common discharge line downstream from the parallel mixing lines to form a conditioned hydrocarbon feedstock;
(4) stopping flow through a mixing line and causing or allowing a portion of hydrocarbon feedstock material to enter a bypass line, bypass the parallel mixing lines, and combine with the conditioned hydrocarbon feedstock in the common discharge line;
(5) while the portion of the hydrocarbon feedstock material is passing through the bypass line, continuing to mix the hydrocarbon feedstock material and the diluted precursor mixture using at least one other of the parallel mixing lines to form the conditioned hydrocarbon feedstock; and
(6) optionally recycling a portion of the conditioned hydrocarbon feedstock by combining the recycled portion with the hydrocarbon feedstock material and/or the diluted precursor mixture.

In general, systems for dispersing a catalyst precursor into a hydrocarbon feedstock to form a conditioned hydrocarbon feedstock containing at least one nonpetroleum-derived hydrocarbon material for subsequent processing using the illustrated method associated with FIG. 3 comprise means (e.g., apparatus configured) for performing the steps recited in the preceding paragraph.

FIG. 4 schematically illustrates another example mixing system 400 that incorporates a plurality of (e.g., two) mixing lines and a recirculation line in case a mixing line needs to be taken offline for maintenance. The main difference between the mixing system 400 of FIG. 4 and the mixing system 300 of FIG. 3 is the mixing of at least one additional hydrocarbon feedstock material and the incorporation of a static inline mixer before dividing the common feedstock stream into multiple streams to be mixed by the plurality of mixing lines. This helps ensure more thorough mixing of hydrocarbon feedstock material and diluted precursor mixture prior to being divided between the different mixing lines.

FIG. 4 more particularly illustrates a mixing system 400 and corresponding method having two parallel mixing lines configured to mix together a plurality of (e.g., two) hydrocarbon feedstock materials, which are advantageously dissimilar from each other, and a dispersed catalyst precursor, to form a conditioned hydrocarbon feedstock for subsequent processing. The mixing system 400 includes feedlines for each of a primary hydrocarbon feedstock material 402, a secondary hydrocarbon feedstock material 406, a dispersed catalyst precursor 410, and a hydrocarbon carrier oil 412. In this embodiment, prior to being mixed with other hydrocarbon feedstock materials, the primary hydrocarbon feedstock material 402 can be optionally premixed by optional static inline mixer 404, and the secondary hydrocarbon feedstock material 406 can be optionally premixed by optional static inline mixer 408. Such pre-mixing may be beneficial in cases where the feedstock materials are a mixture of dissimilar materials and/or which are multi-phase so as to have liquid and solid components.

FIG. 4 further shows the dispersed catalyst precursor 410 and the carrier oil 412 being mixed by a static inline mixer 414 to form a diluted precursor mixture 416. The carrier oil 412 can be as discussed above relative to FIGS. 1-3. The diluted precursor mixture 416 and the secondary hydrocarbon feedstock material 406 can be combined to form a partial feedstream 418, which is combined with the primary hydrocarbon feedstock material 402 to form a combined feedstream 420 prior to mixing. An optional static inline mixture 419 can be used to premix the partial feedstream 418 to disperse the diluted precursor mixture 416 with the secondary hydrocarbon feedstock material 406. Alternatively, the diluted precursor mixture 416 can be premixed with the primary hydrocarbon feedstock material 402 to form a partial feedstream (not shown) prior to mixing with the secondary hydrocarbon feedstock material 406. Premixing the diluted precursor mixture 416 with the primary and/or secondary hydrocarbon feedstock materials 402, 406 can be beneficial to ensure more thorough mixing of the catalyst precursor 410 within the conditioned hydrocarbon feedstock 446.

The primary hydrocarbon feedstock material 402, the secondary hydrocarbon feedstock material 406, and the diluted precursor mixture 416 are combined into feedstream 420 prior to mixing. The combined feedstream 420 is split between first and second parallel mixing lines 422a, 422b. Each mixing line 422a, 422b may include an upstream valve 424a, 424b, which can be selectively opened during operation of the mixing lines 422a, 422b and closed to take a mixing line 422 offline (e.g., for maintenance and cleaning). When the first and second parallel mixing lines 422a, 422b are both online, the upstream valves 424a, 424b are open to permit the divided streams of the combined feedstream 420 to flow through the first and second mixing lines 422a, 422b. One of the upstream valves 424a, 424b can be closed to take one of the mixing lines 422a, 422b offline. In a preferred embodiment, the first and second parallel mixing lines 422a, 422b are designed with symmetrical piping and mixing equipment so that the pressure drop is substantially equal through each parallel mixing line 422a, 422b, and equal flow between the mixing lines 422a, 422b can be maintained. Nevertheless, mixing lines 422a, 422b of different capacity and flow can be used, such as when retrofitting a single train mixing line to include one or more additional mixing lines. It will be appreciated that one or more additional mixing lines (not shown) can be utilized if desired to further increase the capacity of the mixing system 400.

The divided streams of the combined feedstream 420 are initially mixed by first and second static inline mixers 426a, 426b to produce first and second initial mixed streams, which can pass through optional first and second strainers 428a, 428b to remove any undesirable solids in the initial mixed streams. The first and second optionally strained mixed streams are further mixed by first and second high shear mixers 430a, 430b, which provide first and second blended hydrocarbon feedstock streams. Optional first and second flow meters 432a, 432b can be provided to measure flow through the first and second mixing lines 422a, 422b downstream from the first and second high shear mixers 430a, 430b.

The first and second parallel mixing lines 422a, 422b further include first and second flow control devices 434a, 434b positioned downstream from the high shear mixers 430a, 430b. The flow control devices 434a, 434b can provide multiple functions. When the first and second parallel mixing lines 422a, 422b are both online, the flow control devices 434a, 434b will be open. When one of the mixing lines 422 is taken offline, the corresponding flow control device 434 can be closed to prevent backup of pressurized blended feedstock from the other mixing line 422 still in operation. The flow control device 434 of the mixing line 422 that is still in operation can be open all the way or, alternatively, can be partially closed if necessary to restrict flow and increase upstream pressure to cause or allow a portion of the combined feedstream 420 to enter a bypass line 440.

The blended hydrocarbon feedstock streams from the first and second mixing lines 422a, 422b are fed into and combined in a common discharge line 435 to form a common conditioned hydrocarbon feedstock stream 446. The common conditioned hydrocarbon feedstock stream 446 passes through or past a common flow measurement device 438 (e.g., flow meter) and then through a common flow control device 436 (e.g., valve), is recombined with any hydrocarbon feedstock material from the bypass line 440, and enters a surge tank 450 to form a well-mixed conditioned hydrocarbon feedstock for subsequent processing. The conditioned hydrocarbon feedstock can be further processed by downstream processing system(s) 452.

A side stream 454 of the conditioned hydrocarbon feedstock from the surge tank 450 can optionally be recycled, such as by being added to the partial feedstream 418 and/or by providing all or a portion of the hydrocarbon carrier oil 412 used to form the diluted precursor mixture 416. When used as the hydrocarbon carrier oil 412, a cooler 456 can be used to reduce the temperature of the side stream 454 of the conditioned hydrocarbon feedstock to prevent premature thermal decomposition of the catalyst precursor 410 in the diluted precursor mixture 416 prior to being thoroughly mixed with the primary and secondary hydrocarbon feedstock materials 402, 406. When used as all or part of the hydrocarbon carrier oil 412, the side stream 454 of the conditioned hydrocarbon feedstock can be cooled to a temperature of about 75° C. to about 150° C., preferably about 75° C. to about 125° C., and more preferably about 75° C. to about 95° C. In some embodiments, at least a portion of the cooling can be provided by a lower boiling hydrocarbon carrier oil 412 (e.g., vacuum gas oil or cycle oil) that is already at a temperature below the decomposition temperature of the catalyst precursor 410.

When both parallel mixing lines 422a, 422b are online and operational, the common flow control device 436 is open. When one of the mixing lines 422a, 422b is closed and taken offline, such as by closing one or more flow control valves 422, 434, the common flow control device 436 can be partially closed to restrict flow of material through the common discharge line 435 and increase upstream pressure to cause or allow a portion of the combined feedstream 420 and/or one of the primary and secondary hydrocarbon feedstock materials 402, 406 to enter the bypass line 440. The common flow control device 436 can be used alone or in combination with one of the flow control devices 434 corresponding to the mixing line 422 that is still in operation to control upstream pressure.

The bypass line 440 typically does not have hydrocarbon feedstock material flowing through it when both the first and second mixing lines 422a, 422b are online and in operation. However, when one of the parallel mixing lines 422a, 422b is closed and taken offline, the portion of hydrocarbon feedstock material not fed into the remaining online mixing line 422 is caused or allowed to pass through the bypass line 440 to maintain throughput of hydrocarbon feedstock materials through the mixing system 400. As discussed above, flow of hydrocarbon feedstock material though the bypass line 440 is caused or induced by restricting flow through the common discharge line 435 by partially closing common flow control valve 436 and/or the mixing line valve 434 of the operational mixing line 422. This induces a pressure drop and increases upstream pressure sufficient to cause a portion of hydrocarbon feedstock material to enter the bypass line 440.

The bypass line 440 can include an optional static inline mixer 442 to cause at least partial mixing of primary and secondary hydrocarbon feedstock materials 402, 406 and the diluted precursor mixture 416 that may enter the bypass line 440. The bypass line 440 can include an optional flow meter 444 to measure the flow rate of hydrocarbon feedstock material passing through the bypass line 440. The bypass line 440 can include a bypass line valve 448 to control the flow rate and/or pressure of hydrocarbon feedstock material passing through the bypass line 440. The bypass line 440 is joined to the common discharge line 435 to combine hydrocarbon feedstock material from the bypass line 440 with the common conditioned hydrocarbon feedstock stream 446 downstream from the flow control device 436 and flow meter 438.

The flow rates of hydrocarbon feedstock streams that are passed through the remaining operational mixing line 422 and the bypass line 440 can be measured, respectively, by the common flow meter 438 and the optional bypass flow meter 444. The respective flow rates of hydrocarbon feedstock material through the remaining operational mixing line 422 and the bypass line 440 can be adjusted by making adjustments to the common flow control valve 436 and/or the bypass line valve 448. By measuring flow rates using flow meters and making adjustments using flow control devices, a desired balance of flow through the various lines can be achieved and maintained. In addition to adjusting flow rate through the bypass line 440, the bypass line valve 448 can be closed or partially restricted to balance line pressure to ensure that hydrocarbon feedstock material does not pass through the bypass line 440, either in a forward or backward direction, when the first and second mixing lines 422a, 422b are open and operational.

An example method for dispersing a catalyst precursor into a plurality of hydrocarbon feedstock materials to form a conditioned hydrocarbon feedstock containing at least one nonpetroleum-derived hydrocarbon material for subsequent processing using the mixing system 400 illustrated in FIG. 4 comprises:
(1) mixing a catalyst precursor with a hydrocarbon carrier oil by one or more static inline mixers to form a diluted precursor mixture;
(2) mixing a primary hydrocarbon feedstock material, a secondary hydrocarbon feedstock material, and the diluted precursor mixture by a plurality of parallel mixing lines to form a plurality of conditioned hydrocarbon feedstock streams, each parallel mixing line including one or more static inline mixers, optionally a strainer, one or more high shear mixers, and at least one valve for regulating flow in the mixing line;
(3) optionally premixing the diluted precursor mixture with the secondary hydrocarbon feedstock material prior to mixing the hydrocarbon feedstock materials and the diluted precursor mixture by the plurality of parallel mixing lines;
(4) combining the conditioned hydrocarbon feedstock streams in a common discharge line downstream from the parallel mixing lines to form a conditioned hydrocarbon feedstock;
(5) stopping flow through a mixing line and causing or allowing a portion of hydrocarbon feedstock material to enter a bypass line, bypass the parallel mixing lines, and combine with the conditioned hydrocarbon feedstock in the common discharge line;
(6) while the portion of the hydrocarbon feedstock material is passing through the bypass line, continuing to mix the primary and secondary hydrocarbon feedstock materials and the diluted precursor mixture using at least one other of the parallel mixing lines to form the conditioned hydrocarbon feedstock; and
(7) optionally recycling a portion of the conditioned hydrocarbon feedstock by combining the recycled portion with the primary hydrocarbon feedstock material, the secondary hydrocarbon feedstock material, and/or the diluted precursor mixture.

In general, systems for dispersing a catalyst precursor into a plurality of hydrocarbon feedstock materials to form a conditioned hydrocarbon feedstock containing at least one nonpetroleum-derived hydrocarbon material for subsequent processing using the illustrated method associated with FIG. 4 comprise means (e.g., apparatus configured) for performing the steps recited in the preceding paragraph.

Additional apparatus may be included downstream from the mixing systems illustrated in FIGS. 1-4 for providing additional mixing of the diluted precursor mixture and hydrocarbon feedstock materials and to better disperse the catalyst precursor. For example, the mixing lines shown in FIGS. 1-2 can be followed by a surge tank, such as the surge tanks 338, 450 shown in FIGS. 3 and 4, respectively, with recirculation pump(s), and optionally one or more multi-stage centrifugal pumps and a second surge tank (not shown). Further mixing can be carried out using a high energy pump having multiple chambers (not shown) within which the dissimilar hydrocarbon feedstock materials and optional catalyst precursor are churned and mixed as part of the pumping process itself used to deliver the conditioned hydrocarbon feedstock to downstream processing system(s).

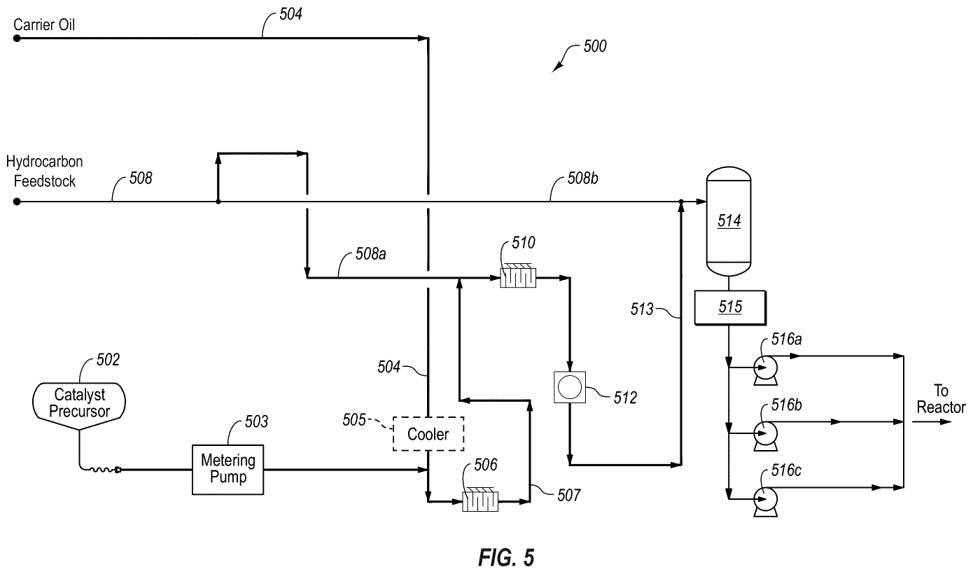

FIG. 5 schematically illustrates an example mixing system that includes one or more multi-stage centrifugal pumps for pressurizing the conditioned hydrocarbon feedstock preparatory to downstream processing, such as hydroprocessing, hydroconversion, hydrocracking, hydrotreating, solvent deasphalting, and/or coking. Example downstream processing equipment may include one or more of the following: ebullated bed rector, slurry phase reactor, fixed bed reactor, solvent deasphalting system, coking unit (delayed coking and/or Flexicoking), fluid catalytic cracking unit, strainer, filter, pump, furnace, heat exchanger, separator, tank, atmospheric distillation column, and vacuum distillation column.

FIG. 5 more particularly illustrates an exemplary system 500 for intimately mixing a catalyst precursor 502 with a hydrocarbon feedstock 508. The catalyst precursor 502 is metered through a metering pump 503 to deliver a desired flow rate. The catalyst precursor 502 is then mixed with a carrier oil 504 in a first static inline mixer 506 to form a diluted catalyst mixture 507. The catalyst precursor 502 is mixed with the carrier oil 504 at a temperature below which a significant portion of the catalyst precursor 502 begins to decompose. If the carrier oil 504 is initially too hot, e.g., hotter than the decomposition temperature of the catalyst precursor 502, it can be first passed through an optional cooler 505 to reduce its temperature, e.g., to below the decomposition temperature of the catalyst precursor 502.

In the illustrated system 500, the hydrocarbon feedstock 508 is divided into first and second partial feedstock streams 508a, 508b for progressive mixing with the diluted precursor mixture 507. Initially, the diluted precursor mixture 507 from the first static inline mixer 506 is mixed with the first partial feedstock stream 508a in a second static inline mixer 510, followed by a high shear mixer 512 to form a partial mixed feedstock stream 513. The partial mixed feedstock stream 513 and the second partial feedstock stream 508b are combined and mixed in a surge tank 514 with pump around (not shown) to form a conditioned hydrocarbon feedstock in which the catalyst precursor 502 is thoroughly mixed throughout the hydrocarbon feedstock 508.

Additional apparatus may be included downstream for providing even more thorough mixing of the catalyst precursor 502 within the conditioned hydrocarbon feedstock. For example, the system 500 may include multiple warm surge tanks 514 (not shown) arranged in parallel or in series with multiple recirculation pumps. The system 500 may include additional processing equipment 515, such as one or more multi-stage centrifugal pumps and/or a hot surge tank. Illustrated system 500 further includes multiple high energy pumps 516a, 516b, 516c arranged in parallel, which, as discussed more fully below, can effect further mixing by intense internal churning within multiple compression stages.

In the mixing system 500 of FIG. 5, only a portion of the hydrocarbon feedstock 508 (i.e., the first partial feedstock stream 508a) is initially mixed with the diluted precursor mixture 507. Although illustrated as dividing feedstock 508 into first and second partial feedstock streams 508a and 508b, it is understood that all of the hydrocarbon feedstock 508 may be added at once (i.e., there may be no division of feedstock 508) or feedstock 508 may be divided into more streams for progressive blending with the catalyst precursor 502. The conditioned feedstock 513 may be introduced along with any remaining heavy oil feedstock 508b into the surge tank(s) 514. The surge tank(s) 514 may be used to more fully diffuse the catalyst precursor 502 throughout the hydrocarbon feedstock 508. The surge tank(s) 514 may provide a residence time between 5 minutes and 60 minutes, or between 10 minutes and 50 minutes, or between 15 minutes and 30 minutes. Through diffusion, the catalyst precursor 502 within the surge tank(s) 514 continues to diffuse more completely throughout the conditioned hydrocarbon feedstock preparatory to heating of the feedstock and decomposition of the catalyst precursor to form active catalyst particles.

Thereafter, the conditioned hydrocarbon feedstock is pumped out of the surge tank(s) 514 and the additional processing equipment 515 by the high pressure pumps 516a, 516b, 516c and delivered to a processing system, such as a hydroprocessing reactor. The pumps 516a, 516b, 516c may comprise multi-stage high pressure pumps. When configured with multiple compression stages (e.g., more than about 10), the pumps 516 provide further intense churning and mixing of the conditioned hydrocarbon feedstock, ensuring thorough mixing of the catalyst precursor 502 within the hydrocarbon feedstock 508. The conditioned hydrocarbon feedstock delivered to the hydroprocessing reactor includes the catalyst precursor dispersed throughout the hydrocarbon feedstock down to the molecular level, such that upon heating and decomposition of the catalyst precursor to form active catalyst particles, the catalyst particles are advantageously colloidal or molecular in size and highly dispersed.

The illustrated system 500 includes three pumps in parallel (e.g., pumps 516a, 516b, and 516c). Configuring the system 500 so that the pumps 516 are in parallel provides for increased flow rate of conditioned hydrocarbon feedstock delivered to downstream processing apparatus. In alternative embodiments, the pumps 516 may be situated so as to be in series or a combination of series and parallel pumps. Placing pumps 516 in series (not shown) effectively increases the number of intense mixing stages through which the conditioned hydrocarbon feedstock passes. For example, two pumps in series, each including five stages, could be used instead of a single pump including ten stages to achieve substantially the same intimate mixing of the catalyst precursor within the hydrocarbon feedstock.

The mixing time in the static in-line mixers depends on the number of stages and the volumetric flow of the components. Increasing the vigorousness and/or shearing energy of the mixing process within the high shear mixers can reduce the mixing time required to effect thorough mixing of catalyst precursor within the hydrocarbon feedstock. The mixing time in the static in-line mixers may advantageously comprise a majority of the total mixing time (not counting surge tanks). Such a configuration uses the pressure drop of the static inline mixers to advantageously achieve a degree of mixing, followed or preceded by additional mixing within the high shear mixer(s).

The duration of mixing within the one or more static inline mixers in a mixing station can be in a range of about 0.1 second to about 5 minutes, or in a range of about 0.5 second to about 1 minute, or in a range of about 1 second to about 10 seconds, and the duration of mixing within the one or more high shear mixers in a mixing station can be in a range of about 0.1 second to about 5 minutes, or in a range of about 0.5 second to about 3 minutes, or in a range of about 1 second to about 1 minute.

The degree of mixing achieved within the static inline mixers used in the disclosed embodiments is dependent, at least in part, on the number of stages. In some embodiments, the static inline mixers may include 2 to 20 stages, preferably 7 to 15 stages, and more preferably 8 to 12 stages. In mixing theory, each “stage” is substantially equivalent to having a vessel that is vigorously stirred. Because mixing is imperfect (i.e., there is some short circuiting of the vessel by the components to be mixed), the degree of mixing is improved if a series of mixing vessels (i.e., stages) are used. An exemplary static inline mixer includes no moving parts but a plurality of internal baffles or other elements inside a tube or other housing. The internal baffles or other elements channel the flowing fluid in many different directions by repeatedly dividing and recombining the fluid in a turbulent manner so as to mix the various components. The number of stages in a static inline mixer empirically correlates to the degree of mixing that can be expected within the static mixer when compared to the degree of mixing that would occur if using a series of mixing vessels (i.e., the fluid leaving the first vessel enters the second vessel for mixing, the fluid leaving the second vessel enters the third vessel, and so on). In other words, a static inline mixer characterized as including 10 stages provides a degree of mixing that is substantially equivalent to that provided by a mixing system comprising a series of 10 mixing vessels.

Advantageously, it has been found that pre-blending a catalyst precursor with a carrier oil to form a diluted precursor mixture, which is then mixed with a hydrocarbon feedstock greatly aids in thoroughly and intimately blending the catalyst precursor within the hydrocarbon feedstock. Forming a diluted precursor mixture advantageously shortens the overall mixing time by (1) reducing or eliminating differences in solubility between the more polar catalyst precursor and the hydrocarbon feedstock, (2) reducing or eliminating differences in viscosity between the catalyst precursor and the hydrocarbon feedstock, and/or (3) breaking up bonds or associations between clusters of catalyst precursor molecules to form a solute within the carrier oil, which is more easily dispersed within the hydrocarbon feedstock.

It can be advantageous to form a diluted precursor mixture when the hydrocarbon feedstock contains water (e.g., condensed water). Otherwise, the greater affinity of the water for the polar catalyst precursor can cause localized agglomeration of catalyst precursors, such as molybdenum 2-ethylhexanoate that are unstable when exposed to water, resulting in poor dispersion and formation of micron-sized or larger catalyst particles. In such cases, the carrier oil is preferably substantially water free (i.e., contains less than about 0.5%, 0.3%, or 0.1% by weight of water) to prevent formation of substantial quantities of micron-sized or larger catalyst particles. Water is not a problem with catalyst precursors (e.g., metal carbamates) that are not unstable when exposed to water.

The systems and methods discussed above relative to FIGS. 1-5 can be used to mix a catalyst precursor with a hydrocarbon carrier oil to form a diluted precursor mixture, which is blended with one or more hydrocarbon feedstock materials to form a conditioned hydrocarbon feedstock containing one or more nonpetroleum-derived hydrocarbons and typically one or more petroleum-derived hydrocarbons.

The carrier oil can be used in amounts ranging from 0.1% to 33%, or about 0.3% to about 25%, or about 0.5% to about 20%, or about 0.75% to about 15%, or about 1% to about 10%, or about 1.5% to about 5%, by volume of the total conditioned hydrocarbon feedstock.

In some embodiments, the conditioned hydrocarbon feedstock may comprise about 50% to about 100% by weight of nonpetroleum-derived hydrocarbon materials and 0% to 50% by weight of petroleum-derived hydrocarbon materials. In other embodiments, the conditioned hydrocarbon feedstock may comprise about 1% to about 50% by weight of nonpetroleum-derived hydrocarbon materials and about 50% to about 99% by weight of petroleum-derived hydrocarbon materials.

In the case where one or more petroleum-derived hydrocarbons are mixed with one or more nonpetroleum-derived hydrocarbons, the conditioned hydrocarbon feedstock may comprise at least about 1%, 3%, 5%, 10%, 15%, 20%, 30%, 40%, or 50% and less than about 99%, 97%, 95%, 90%, 85%, 80%, 70%, 60%, or 50%, by weight of the one or more petroleum-derived materials (or in a range defined by any two of the foregoing values) and at least about 1%, 3%, 5%, 10%, 15%, 20%, 30%, 40%, or 50% and less than about 99%, 97%, 95%, 90%, 85%, 80%, 70%, 60%, or 50%, by weight of the one or more nonpetroleum-derived materials (or in a range defined by any two of the foregoing values).

In some embodiments, such as where one or more nonpetroleum-derived materials are solid at the temperature at which they are mixed with one or more other hydrocarbon materials, it can be advantageous to liquify and/or comminute any initially solid hydrocarbon materials to a particle size of about 50 mesh (about 300 μm) or smaller, or about 70 mesh (about 210 μm) or smaller, or about 100 mesh (about 150 μm) or smaller.

The catalyst precursor is advantageously mixed with the hydrocarbon carrier oil below a temperature at which a significant portion of the catalyst precursor decomposes. The mixing may be performed at temperature in a range of about 40° C. (104° F.) to about 250° C. (482° F.), or in range of about 60° C. (140° F.) to about 200° C. (392° F.), or in a range of about 75° C. (167° F.) to about 125° C. (257° F.), to form the diluted precursor mixture. The temperature at which the diluted precursor mixture is formed may depend on the decomposition temperature and/or other characteristics of the catalyst precursor that is utilized and/or characteristics of the hydrocarbon carrier oil, such as viscosity.

The hydrocarbon feedstock material and diluted precursor mixture are advantageously mixed at a temperature in a range of about 40° C. (104° F.) to about 350° C. (662° F.), or in a range of about 60° C. (140° F.) to about 300° C. (572° F.), or in a range of about 75° C. (167° F.) to about 250° C. (482° F.) to yield a conditioned hydrocarbon feedstock.

Because the catalyst precursor is premixed with the carrier oil to form a diluted precursor mixture, which is thereafter mixed with the hydrocarbon feedstock material(s), it may be permissible for the hydrocarbon feedstock material(s) to be at or above the decomposition temperature of the catalyst precursor. In some cases, the carrier oil shields the individual catalyst precursor molecules and prevents them from agglomerating to form larger particles, temporarily insulates the catalyst precursor molecules from heat from the hydrocarbon feedstock materials during mixing, and facilitates dispersion of the catalyst precursor molecules sufficiently quickly throughout the hydrocarbon feedstock materials before decomposing to liberate metal and form dispersed metal sulfide catalyst particles. In addition, additional heating of the conditioned hydrocarbon feedstock may be necessary to liberate hydrogen sulfide from sulfur-bearing molecules in the conditioned hydrocarbon feedstock to form the dispersed metal sulfide catalyst particles. In this way, progressive dilution of the catalyst precursor permits a high level of dispersion within the conditioned hydrocarbon feedstock, resulting in the formation of highly dispersed metal sulfide catalyst particles in situ, even where the feedstock is at a temperature above the decomposition temperature of the catalyst precursor. In some cases, a source of sulfur-bearing hydrocarbons can be added to sulfur-deficient hydrocarbon feedstock materials in order to form the dispersed metal sulfide catalyst particles. Metal from the catalyst precursor may initially form a metal oxide, which then reacts with sulfur in the conditioned hydrocarbon feedstock to yield a metal sulfide compound that forms the final active catalyst.

After the catalyst precursor has been well-mixed throughout the hydrocarbon feedstock material, the conditioned hydrocarbon feedstock is heated to cause decomposition of the catalyst precursor, which liberates catalyst metal therefrom, causes or allows catalyst metal to react with sulfur within and/or added to the hydrocarbon feedstock material, and forms the active metal sulfide catalyst particles in situ. Metal from the catalyst precursor may initially form a metal oxide, which then reacts with sulfur in the hydrocarbon feedstock material to yield a metal sulfide compound that forms the final active catalyst. In the case where the hydrocarbon feedstock material includes sufficient or excess sulfur, the final activated catalyst may be formed in situ by heating the feedstock to a temperature sufficient to liberate sulfur therefrom. In some cases, sulfur may be liberated at the same temperature that the catalyst precursor decomposes. In other cases, further heating to a higher temperature may be required. Hydrogen sulfide gas can be added to hydrocarbon feedstock material that lacks sufficient sulfur to form active metal sulfide catalyst particles.

If the catalyst precursor is thoroughly mixed throughout the conditioned hydrocarbon feedstock, at least a substantial portion of the liberated metal ions will be sufficiently sheltered or shielded from other metal ions so that they can form a molecularly dispersed catalyst upon reacting with sulfur to form the metal sulfide compound. Under some circumstances, minor agglomeration may occur, yielding colloidal-sized catalyst particles. However, it is believed that taking care to thoroughly mix the catalyst precursor throughout the conditioned hydrocarbon feedstock prior to thermal decomposition of the catalyst precursor may yield individual catalyst molecules rather than colloidal particles. Simply blending, while failing to sufficiently mix, the catalyst precursor with the conditioned hydrocarbon feedstock typically causes formation of large, agglomerated metal sulfide compounds that are micron-sized or larger.

In order to form dispersed metal sulfide catalyst particles, the conditioned hydrocarbon feedstock is heated to a temperature in a range of about 275° C. (527° F.) to about 450° C. (842° F.), or in a range of about 310° C. (590° F.) to about 430° C. (806° F.), or in a range of about 330° C. (626° F.) to about 410° C. (770° F.).

The concentration of catalyst metal provided by the dispersed metal sulfide catalyst particles in the conditioned hydrocarbon feedstock can depend on the type of reactor being employed. In the case where the dispersed metal sulfide catalyst is used together with a solid supported catalyst (e.g., ebullated bed reactor or fixed bed reactor), the concentration can be in a range of about 1 ppm to about 150 ppm by weight, or in a range of about 5 ppm to about 95 ppm by weight, or in a range of about 10 ppm to about 75 ppm by weight, of the conditioned hydrocarbon feedstock. In the case where the dispersed metal sulfide catalyst is the only catalyst being employed (e.g., slurry reactor), the concentration will typically be higher, such as in a range of about 30 ppm to about 1000 ppm by weight, or in a range of about 50 ppm to about 500 ppm by weight, or in a range of about 75 ppm to about 300 ppm by weight, of the conditioned hydrocarbon feedstock.

In the case where the conditioned hydrocarbon feedstock includes asphaltene molecules, the dispersed metal sulfide catalyst particles may preferentially associate with or remain in close proximity to the asphaltene molecules. Asphaltene molecules can have a greater affinity for the metal sulfide catalyst particles since asphaltene molecules are generally more hydrophilic and less hydrophobic than other hydrocarbons contained in heavy oil, when included in the conditioned hydrocarbon feedstock. Because metal sulfide catalyst particles tend to be hydrophilic, the individual particles or molecules will tend to migrate toward more hydrophilic moieties or molecules within heavy oil.

Systems for dispersing a catalyst precursor into hydrocarbon feedstock material to form a conditioned hydrocarbon feedstock for subsequent processing comprise means for performing the method steps disclosed herein. In addition to supply lines and mixers, such as the static-inline mixers and high shear mixers discussed herein, the system may further comprise processing equipment selected from the group consisting of strainers, filters, pumps, furnaces, heat exchangers, reactors, separators, tanks, and distillation columns.

The conditioned hydrocarbon feedstocks formed according to the systems and methods disclosed herein, including the example systems and methods illustrated to FIGS. 1-6 discussed above, can be further processed by processing methods and systems known in the art, including one or more of hydrocracking or hydroconversion (e.g., by ebullated bed, fixed bed, or slurry bed reactor), solvent deasphalting, coking (delayed coking and/or Flexicoking), fluid catalytic cracking, hydroprocessing, or hydrotreating.

### IV. Example Hydroprocessing Systems

Example ebullated bed hydroprocessing systems that utilize a dual catalyst system comprised of a heterogeneous catalyst and dispersed metal sulfide particulate catalyst are disclosed in U.S. Pat. No. 10,118,146. Example hydroprocessing systems that utilize a dispersed metal sulfide particulate catalyst in a slurry phase reactor are disclosed in U.S. Pat. No. 7,578,928. Example fixed bed hydroprocessing systems that utilize a dual catalyst system comprised of a heterogeneous catalyst and dispersed metal sulfide particulate catalyst are disclosed in U.S. Pat. No. 7,517,446. Example combined hydroprocessing and thermal coking systems are disclosed in U.S. Pat. No. 9,644,157. Example combined hydroprocessing and deasphalting systems are disclosed in U.S. Pat. No. 11,834,616. The foregoing patents are incorporated by reference in their entirety.

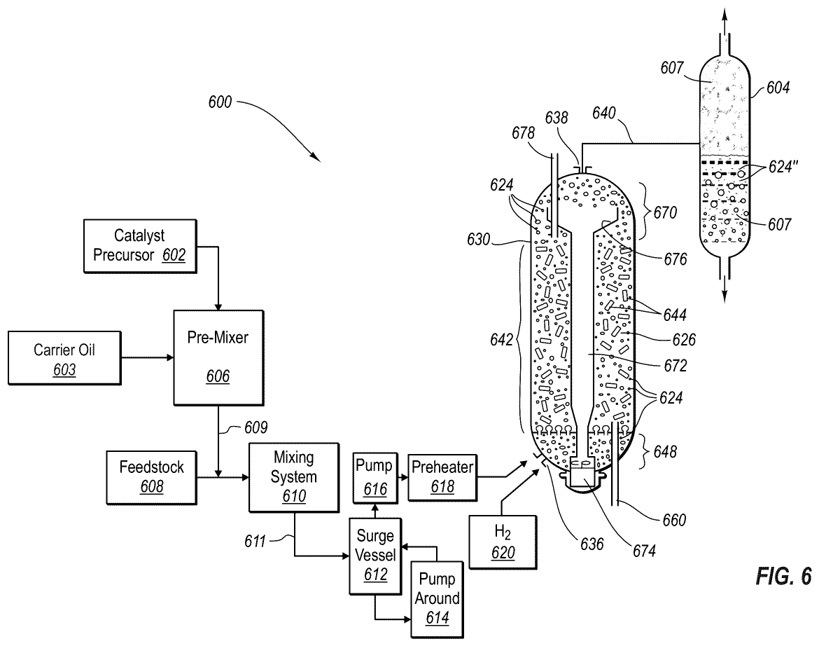

FIGS. 6-9 illustrate example hydroprocessing reactors and systems that can be used with the disclosed methods and systems for mixing a catalyst precursor into a hydrocarbon feedstock using a carrier oil to form a conditioned hydrocarbon feedstock. The conditioned feedstock is heated to decompose the catalyst precursor to form dispersed metal sulfide catalyst particles in situ within the hydrocarbon feedstock. Heating can be performed upstream from and/or within the hydroprocessing reactor.

FIG. 6 schematically illustrates an example ebullated bed hydroprocessing system 600 that utilizes a dual catalyst system of dispersed metal sulfide catalyst particles and a heterogenous ebullated bed catalyst. The ebullated bed hydroprocessing system 600 includes an ebullated bed reactor 630 and a separator 604 (such as a hot separator, inter-stage pressure differential separator, or distillation tower). The ebullated bed reactor 630 is similar to that used in the LC-Fining hydrocracking system developed by C-E Lummus. A catalyst precursor 602 is blended with a carrier oil 603 in one or more pre-mixers 606 to form a diluted precursor mixture 609. The diluted precursor mixture 609 is added to and blended with a hydrocarbon feedstock 608 using a mixing system 610 to form a conditioned hydrocarbon feedstock 611.

The conditioned hydrocarbon feedstock 611 is fed into a surge tank or vessel 612 with a pump around loop 614 to effect further mixing and dispersion of the catalyst precursor 602 within the hydrocarbon feedstock 608. A bypass line (not shown) returns any hydrocarbon feedstock that bypasses the mixing lines (not shown) to a common discharge line (not shown) and/or feeds the hydrocarbon feedstock directly into the surge vessel 612. The surge vessel 612 and pump around loop 614 advantageously effect further mixing of the catalyst precursor into the hydrocarbon feedstock 608, including any hydrocarbon feedstock from the bypass line. The conditioned hydrocarbon feedstock from the surge vessel 612 is pressurized by one or more pumps 616, passed through a pre-heater 618, and fed into the ebullated bed hydroprocessing reactor 630 together with hydrogen gas 620 through one or more inlet ports 636 located at or near the bottom of the ebullated bed reactor 630.

The ebullated bed reactor 630 includes a hydrocarbon material 626 and an expanded catalyst zone 642 comprising a heterogeneous catalyst 644 typical for ebullated bed reactors, which is maintained in an expanded or fluidized state against the force of gravity by upward movement of liquid hydrocarbons 626 and gas. A lower heterogeneous catalyst free zone 648 is located below a distributor grid plate defining the bottom of the expanded catalyst zone 642, and an upper heterogeneous catalyst free zone 670 is located above the expanded catalyst zone 642. Dispersed metal sulfide catalyst particles 624 are dispersed throughout the hydrocarbon material 626 within the ebullated bed reactor 630, including in the expanded catalyst zone 642 and the heterogeneous catalyst free zones 648, 670, thereby being available to promote beneficial upgrading reactions in the absence of the heterogeneous catalyst 644.

A funnel-shaped recycle cup 676 that feeds into a recycling channel 672 and associated ebullating pump 674 continuously recirculate the hydrocarbon material 626 from the upper heterogeneous catalyst free zone 670 to the lower heterogeneous catalyst free zone 648. Downward suction by the recycle cup 676 at the top of the recycling channel 672 draws the hydrocarbon material 626 containing the dispersed catalyst particles 624 from the upper heterogeneous catalyst free zone 670 down through the recycling channel 672 and into the bottom of the ebullated bed reactor 630 by the ebullating pump 674. The recycled hydrocarbon material 626 is blended with new hydrocarbon feedstock containing dispersed metal sulfide catalyst particles (and/or catalyst precursor) and hydrogen gas 620.

Fresh heterogeneous catalyst 644 can be introduced periodically into the ebullated bed reactor 630 through a catalyst inlet tube 678 and spent heterogeneous catalyst 644 can be withdrawn periodically through a catalyst withdrawal tube 660. The dispersed metal sulfide catalyst particles 624 provide additional catalytic activity within expanded catalyst zone 642, recycle channel 672, and lower and upper heterogeneous catalyst free zones 648, 670. The catalytic addition of hydrogen to hydrocarbons outside of the heterogeneous catalyst 644 reduces or minimizes formation of sediment and coke precursors, which are often responsible for deactivating the heterogeneous catalyst 644 and causing system fouling.

The ebullated bed reactor 630 further includes an outlet port 638 at or near the top through which converted materials 640 are withdrawn. The converted materials 640 are introduced into a separator 604, which separates a volatile fraction 605 from a resid fraction 607. The volatile fraction 605 is withdrawn from the top of the hot separator 604, and the resid fraction 607 is withdrawn from the bottom of the hot separator 604. The resid fraction 607 contains residual dispersed metal sulfide catalyst particles, schematically depicted as catalyst particles 624″. If desired, at least a portion of the resid fraction 607 can be recycled back to the ebullated bed reactor 630 to form part of the feedstock and provide supplemental dispersed metal sulfide catalyst particles. Alternatively, the resid fraction 607 can be further processed using downstream processing equipment, such as another ebullated bed reactor, a distillation tower, a deasphalting unit, a coking unit, and the like. A portion of the resid fraction 607 can be used as part or all of the carrier oil 603 added to the pre-mixer 606 to form the diluted catalyst precursor 609.

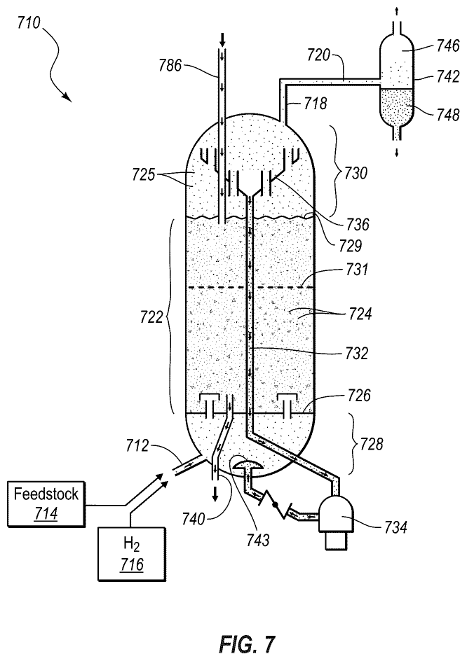

FIG. 7 schematically illustrates another type of ebullated bed hydroprocessing reactor 710 having a different recirculating system typical of the H-Oil hydrocracking system developed by Hydrocarbon Research, Inc. The ebullated bed reactor 710 includes an inlet port 712 through which a hydrocarbon feedstock 714 and pressurized hydrogen gas 716 are introduced, and an outlet port 718 through which upgraded hydrocarbon material 720 is withdrawn.

An expanded catalyst zone 722 comprising a heterogeneous catalyst 724 is bounded by a distributor grid plate 726, which separates the expanded catalyst zone 722 from a lower catalyst free zone 728, and an upper end 729, which defines an approximate boundary between the expanded catalyst zone 722 and an upper catalyst free zone 730. A dotted boundary line 731 schematically illustrates the approximate level of the heterogeneous catalyst 724 when not in an expanded or fluidized state. Dispersed metal sulfide catalyst particles 725 are dispersed throughout the hydrocarbon material in the ebullated bed reactor 710, both in the expanded catalyst zone 722 and in the lower and upper heterogeneous catalyst free zones 728, 730.

Hydrocarbons and other materials in the ebullated bed reactor 710 are continuously recirculated by a recycling channel 732 connected to an ebullating pump 734 positioned outside of the reactor 710. Materials are drawn through a funnel-shaped recycle cup 736 from the upper heterogeneous catalyst free zone 730. The recycle cup 736 helps separate hydrogen bubbles from recycled material passing down through recycle channel 732 to prevent cavitation in the ebullating pump 734. The recycled material enters the lower heterogeneous catalyst free zone 728 through a discharge bell cap 743, where it is blended with fresh heavy oil feedstock 714 and hydrogen gas 716. This mixture passes up through the distributor grid plate 726 and into the expanded catalyst zone 722. Fresh heterogeneous catalyst can be introduced periodically into the expanded catalyst zone 722 through a catalyst inlet tube 786 and spent heterogeneous catalyst can be periodically withdrawn through a catalyst discharge tube 740.

The main difference between the H-Oil ebullated bed reactor 710 illustrated in FIG. 7 and the LC-Fining ebullated bed reactor 600 illustrated in FIG. 6 is the location of the ebullating pump. The ebullating pump 734 in the H-Oil reactor 710 is located external to the reaction chamber. The recirculated material is introduced through a recirculation port with distributor cap 743 at the bottom of the ebullated bed reactor 710. The distributor cap 743 aids in evenly distributing materials through the lower catalyst free zone 728.

Upgraded material 720 is withdrawn from the outlet port 718 of the ebullated bed reactor 710 and introduced into a separator 742 (e.g., hot separator, inter-stage pressure differential separator, atmospheric distillation tower, or vacuum distillation tower). The separator 742 is configured to separate a volatile fraction (gas and distillates) 746 from a non-volatile fraction (or liquid) 748. The distillates and gases 746 are removed at one location (e.g., top) of the separator 742, and a non-volatilized fraction 748 containing liquid hydrocarbons and residual dispersed metal sulfide catalyst particles are removed from another location (e.g., bottom) of the separator 742.

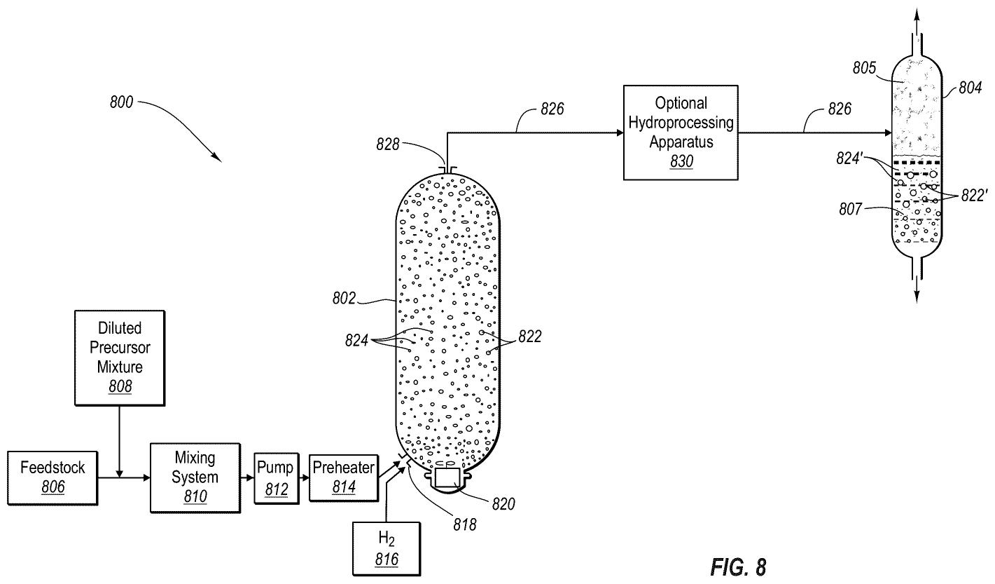

FIG. 8 schematically depicts a hydroprocessing system 800 that includes a slurry phase reactor 802 and a separator 804 (e.g., hot separator, interstage pressure-differential separator, or distillation tower). A hydrocarbon feedstock 806 is blended and conditioned with a diluted precursor mixture 808 using a mixing system 810. The diluted precursor mixture 808 comprises a catalyst precursor mixed with a carrier oil formed in a pre-mixer (not shown). The conditioned feedstock from the mixing system 810 is pressurized by a pump 812, which can also serve as a multi-stage mixing device to further disperse the catalyst precursor throughout the hydrocarbon feedstock 806, passed through a pre-heater 814, and fed into the slurry phase reactor 802 together with hydrogen gas 816 through one or more inlet ports 818 located at or near the bottom of the slurry phase reactor 802.

A stirrer 820 at the bottom of the slurry phase reactor 802 induces mixing within the liquid phase, thus helping to more evenly disperse the heat generated by the hydrocracking reactions. Alternatively, or in addition to the stirrer 820, the slurry phase reactor 802 may include a recycle channel, recycling pump, and distributor grid plate (not shown) as in conventional ebullated bed reactors (See FIGS. 6-7) to promote more even dispersion of reactants, catalyst, and heat. Hydrogen is schematically depicted as gas bubbles 822, and dispersed metal sulfide catalyst particles are schematically depicted as catalyst particles 824 in the reactor 802. It will be appreciated that gas bubbles 822 and catalyst particles 824 are shown oversized so that they may be seen in the drawing. In reality, they may be invisible to the naked eye.

The hydrocarbon feedstock 806 is catalytically upgraded in the presence of the hydrogen 816 and dispersed metal sulfide catalyst 824 within the slurry phase reactor 802 to form an upgraded hydrocarbon product 826. The upgraded product 826 is continuously withdrawn from the slurry phase reactor 802 through an outlet port 828 located at or near the top of the reactor 802, optionally fed into optional hydroprocessing apparatus 830, and fed into the separator 804 (e.g., hot separator and/or distillation tower). The upgraded product 826 fed to the separator 804 contains residual catalyst particles, schematically depicted as particles 824′, and residual hydrogen, schematically depicted as bubbles 822′, which can continue promoting beneficial upgrading reactions and reduce equipment fouling. The separator 804 separates the volatile fraction 805 from a non-volatile fraction 807. The volatile fraction 805 is withdrawn from the top of separator 804, and the non-volatile fraction 807 is withdrawn from the bottom of separator 804.

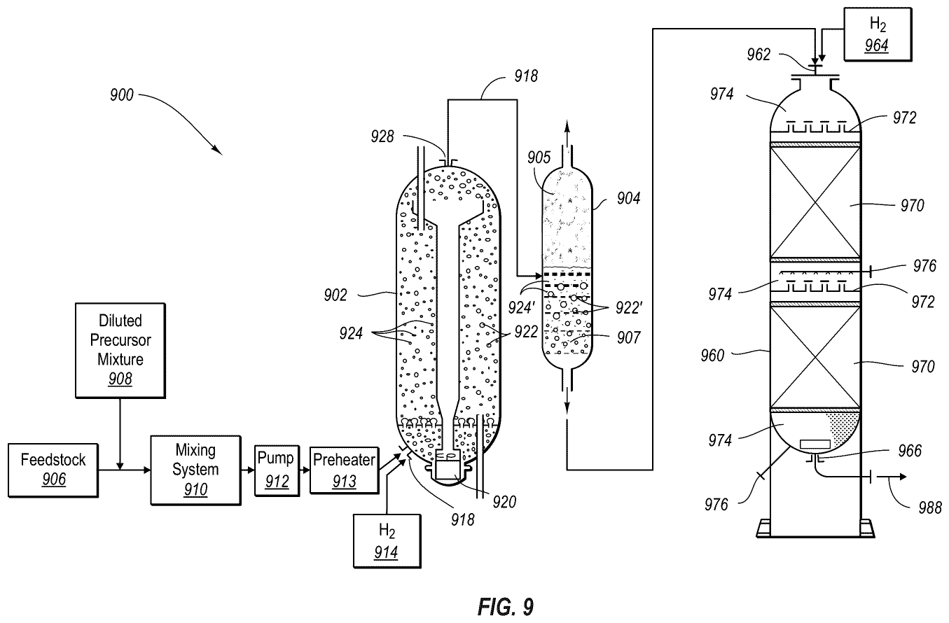

FIG. 9 schematically depicts a hydroprocessing system 900 that includes a slurry phase reactor 902, a separator 904, and a fixed bed reactor 960. A hydrocarbon feedstock 906 is mixed with a diluted precursor mixture 908 (containing a catalyst precursor and carrier oil) by a mixing system 910 to form a conditioned feedstock. The conditioned feedstock is pressurized by a pump 912, passed through a preheater 913 to at least partially decompose the catalyst precursor and form dispersed metal sulfide catalyst particles in situ, and fed into the slurry phase reactor 902 together with hydrogen gas 914 through inlet port 918. A stirrer 920 at the bottom of the slurry phase reactor 902 induces mixing within the liquid phase, thus helping to more evenly disperse the heat generated by the hydrocracking reactions. Hydrogen is schematically depicted as gas bubbles 922, and dispersed metal sulfide catalyst particles are schematically depicted as catalyst particles 924.

The hydrocarbon feedstock 906 is catalytically upgraded in the presence of the hydrogen 922 and dispersed metal sulfide catalyst 924 within the slurry phase reactor 902 to form an upgraded hydrocarbon product 918. The upgraded product 918 is withdrawn from the slurry phase reactor 902 through an output port 928 located at or near the top of the reactor 902. The effluent 918 containing upgraded products is fed into a separator 904 (e.g., hot separator and/or distillation tower), which separates volatile and gaseous materials 905 from non-volatile materials 907. The upgraded hydrocarbon material 918 contains residual dispersed metal sulfide catalyst particles, schematically depicted as particles 924′, and residual hydrogen, schematically depicted as bubble 922′, within the separator 904.

The liquid fraction 907 and residual dispersed metal sulfide catalyst particles 924′ from the separator 904 are introduced into the fixed bed reactor 960 for further hydroprocessing. The fixed bed reactor 960 may be designed to perform hydrocracking and/or hydrotreating reactions depending on the operating temperature and/or the type of porous supported catalyst used within the fixed bed reactor 960.

The fixed bed reactor 960 more particularly includes an inlet port 962 at the top through which the liquid fraction 907 and supplemental hydrogen gas 964 are introduced, and an outlet port 966 at the bottom through which a further hydroprocessed material 988 is withdrawn. The fixed bed reactor 960 further includes a plurality of vertically stacked and spaced apart catalyst beds 970, each comprising a bed of packed porous supported catalyst. Above each catalyst bed 970 is a distributor grid 972, which helps to more evenly distribute the flow of feedstock downward through the catalyst beds 970. Supported catalyst free zones 974 exist above and below each catalyst bed 970. The residual catalyst particles 924′ remain dispersed throughout the feedstock within the fixed bed reactor 960, in both catalyst beds 970 and the supported catalyst free zones 974, which further promote beneficial upgrading reactions. Auxiliary ports 976 in the center and/or bottom of the fixed bed reactor 960 may be provided through which a cooling oil and/or hydrogen quench can be introduced to cool heat generated by the hydroprocessing reactions, control the reaction rate, and thereby help prevent formation of coke precursors and sediment and/or excessive gas within the fixed bed reactor 960.

### V. Examples

The following examples illustrate the formation of conditioned hydrocarbon feedstock by blending dissimilar feedstocks together with a catalyst precursor in a carrier oil. In some cases, the carrier oil comprises a partial stream of one or more of the hydrocarbon feedstocks.

In other cases, the carrier oil comprises a conventional hydrocarbon diluent. The diluted precursor mixture was prepared by mixing an amount of catalyst precursor with an amount of carrier oil to form a diluted precursor mixture and then mixing an amount of the diluted precursor mixture with an amount of hydrocarbon feedstock(s) to achieve the target loading of dispersed catalyst in the conditioned hydrocarbon feedstock. For example, to achieve a target loading of 10-50 ppm (e.g., 30 ppm) of dispersed metal sulfide catalyst in the conditioned hydrocarbon feedstock (where the loading is expressed based on metal concentration, not precursor concentration), the diluted precursor mixture was prepared with a 1000-5000 ppm (e.g., 3000 ppm) concentration of catalyst metal.

### Example 1—Plastic-Derived Feedstock and Petroleum-Derived Feedstock

A mixing system is configured according to any of the embodiments illustrated in FIGS. 1-4 and designed to process a total feed rate of 250 metric tonnes per hour (mt/hr). A first hydrocarbon feedstock is a straight-run vacuum residue derived from distillation of Middle Eastern crude oil and is fed at a rate of 125 mt/hr and a temperature of 150° C. A second hydrocarbon feedstock is a pyrolysis oil derived from mixed plastics and is fed at a rate of 125 mt/hr and a temperature of 150° C. These dissimilar hydrocarbon feedstock materials are ordinarily incompatible, such that it would not be possible to create a stable conditioned hydrocarbon feedstock that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 35 ppm of the dispersed catalyst by weight of the feedstock. The carrier oil may comprise all or a portion of one of the hydrocarbon feedstock materials, a conventional hydrocarbon diluent, such as atmospheric gas oil, vacuum gas oil, decant oil, cycle oil, fluid catalytic cracking (FCC)-derived oil, slurry oil, waste motor oil, diesel, kerosene, or hydrocarbon distillates having a nominal boiling in a range of 200° C. to 524° C., or a combination thereof. If the carrier oil is initially too hot, it can be cooled prior to being mixed with the catalyst precursor. If a separate carrier oil and/or partial feedstock stream is used to form the diluted precursor mixture, it will comprise 2-3 wt % of the total feed and fed at a rate of 5-7.5 mt/hr. The diluted precursor mixture is combined with the remaining hydrocarbon feedstock materials.

The diluted precursor mixture is mixed with the remaining hydrocarbon feedstock materials to form an initial hydrocarbon mixture, which is mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

### Example 2—Bio-Derived Feedstock and Petroleum-Derived Feedstock

A mixing system is configured according to any of the embodiments illustrated in FIGS. 1-4 and designed to process a total feed rate of 250 mt/hr. A first hydrocarbon feedstock is a straight-run vacuum gas oil (VGO) derived from distillation of Middle Eastern crude oil and is fed at a rate of 125 mt/hr and a temperature of 100° C. A second hydrocarbon feedstock is a pyrolysis oil derived from biomass (plant matter) and is fed at a rate of 125 mt/hr and a temperature of 110° C. These dissimilar hydrocarbon feedstock materials are ordinarily incompatible, such that it would not be possible to create a stable conditioned hydrocarbon feedstock that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 15 ppm of the dispersed catalyst by weight of the feedstock. At least a portion of the vacuum gas oil can function as the carrier oil. Alternatively, the carrier oil may comprise a different hydrocarbon diluent, such as atmospheric gas oil, decant oil, cycle oil, fluid catalytic cracking (FCC)-derived oil, slurry oil, waste motor oil, diesel, kerosene, hydrocarbon distillates having a nominal boiling in a range of 200° C. to 524° C., or a combination thereof. If a separate carrier oil and/or partial feedstock stream is used to form the diluted precursor mixture, it will comprise 2-3 wt % of the total feed and fed at a rate of 5-7.5 mt/hr. The diluted precursor mixture is combined with the remaining hydrocarbon feedstock materials.

The diluted precursor mixture is mixed with the remaining hydrocarbon feedstock materials to form an initial hydrocarbon stream, which is mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

### Example 3—Plastic-Derived Feedstock, Bio-Derived Feedstock, and Petroleum-Derived Feedstock

A mixing system is configured according to any of the embodiments illustrated in FIG. 2 or 4 and designed to process a total feed rate of 250 mt/hr. A first hydrocarbon feedstock is a straight-run atmospheric residue (350° C. cut point) derived from distillation of Canadian crude oil such as Cold Lake and is fed at a rate of 125 mt/hr and a temperature of 100° C. A second hydrocarbon feedstock is a pyrolysis oil derived from mixed plastics and is fed at a rate of 62.5 mt/hr and a temperature of 110° C. A third hydrocarbon feedstock is a pyrolysis oil derived from biomass (plant matter) and is fed at a rate of 62.5 mt/hr and a temperature of 110° C. These dissimilar hydrocarbon feedstock materials are ordinarily incompatible, such that it would not be possible to create a stable conditioned hydrocarbon feedstock that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 20 ppm of the dispersed catalyst by weight of the feedstock. The carrier oil may comprise all or a portion of one of the hydrocarbon feedstock materials, a conventional hydrocarbon diluent, such as vacuum gas oil, decant oil, cycle oil, fluid catalytic cracking (FCC)-derived oil, slurry oil, waste motor oil, diesel, kerosene, hydrocarbon distillates having a nominal boiling in a range of 200° C. to 524° C., or a combination thereof. If a separate carrier oil and/or partial feedstock stream is used to form the diluted precursor mixture, it will comprise 2-3 wt % of the total feed and fed at a rate of 5-7.5 mt/hr. If the carrier oil is initially too hot, it can be cooled prior to being mixed with the catalyst precursor. The diluted precursor mixture is combined with the remaining hydrocarbon feedstock materials.

The second and third hydrocarbon feedstocks can be initially pre-mixed by a static inline mixer to form a hydrocarbon pre-mix. The hydrocarbon pre-mix is then combined with the diluted precursor mixture and first hydrocarbon feedstock to form an initial hydrocarbon stream, which mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

### Example 4—Rubber Tire-Derived Feedstock and Petroleum-Derived Feedstock

A mixing system is configured according to any of the embodiments illustrated in FIGS. 1-4 and designed to process a total feed rate of 100 mt/hr. A first hydrocarbon feedstock is dewatered waste motor oil and is fed at a rate of 80 mt/hr and a temperature of 50° C. A second hydrocarbon feedstock is recycled tires which have been pulverized to a particle size of minus 70 mesh (about 210 μm) and demetalized and is fed at a rate of 20 mt/hr and ambient temperature. These dissimilar hydrocarbon feedstock materials are ordinarily incompatible, such that it would not be possible to create a stable conditioned hydrocarbon feedstock that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 50 ppm of the dispersed catalyst by weight of the feedstock. At least a portion of the waste motor oil can function as the carrier oil. Alternatively, the carrier oil may comprise a different hydrocarbon diluent, such as atmospheric gas oil, vacuum gas oil, decant oil, cycle oil, fluid catalytic cracking (FCC)-derived oil, slurry oil, diesel, kerosene, hydrocarbon distillates having a nominal boiling in a range of 200° C. to 524° C., pyrolysis oil, or a combination thereof. If a separate carrier oil and/or partial feedstock stream is used to form the diluted precursor mixture, it will comprise 2-3 wt % of the total feed and fed at a rate of 2-3 mt/hr. The diluted precursor mixture is combined with the remaining hydrocarbon feedstock materials.

For the second hydrocarbon feedstock, which is provided as a solid, the material is conveyed using a screw auger mechanism. The diluted precursor mixture is mixed with the remaining hydrocarbon feedstock materials to form an initial hydrocarbon stream, which is mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

### Example 5—Fabric-Derived Feedstock and Petroleum-Derived Feedstock

A mixing system is configured according to any of the embodiments illustrated in FIGS. 1-4 and designed to process a total feed rate of 250 mt/hr. A first hydrocarbon feedstock is a mixed refinery stream of 60% light cycle oil and 40% slurry oil (FCC-derived) and is fed at a rate of 225 mt/hr and a temperature of 125° C. A second hydrocarbon feedstock is a pyrolysis oil derived from mixed textile fabrics and is fed at a rate of 25 mt/hr and a temperature of 110° C. These dissimilar hydrocarbon feedstock materials are ordinarily incompatible, such that it would not be possible to create a stable conditioned hydrocarbon feedstock that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 10 ppm of the dispersed catalyst by weight of the feedstock. At least a portion of the light cycle oil, slurry oil, or mixed refinery stream can function as the carrier oil. Alternatively, the carrier oil may comprise a different hydrocarbon diluent, such as atmospheric gas oil, vacuum gas oil, decant oil, fluid catalytic cracking (FCC)-derived oil, waste motor oil, diesel, kerosene, hydrocarbon distillates having a nominal boiling in a range of 200° C. to 524° C., or a combination thereof. If a separate carrier oil and/or partial feedstock stream is used to form the diluted precursor mixture, it will comprise 2-3 wt % of the total feed and fed at a rate of 5-7.5 mt/hr. If the carrier oil is initially too hot, it can be cooled prior to being mixed with the catalyst precursor. The diluted precursor mixture is combined with the remaining hydrocarbon feedstock materials.

The diluted precursor mixture is mixed with the remaining hydrocarbon feedstock materials to form an initial hydrocarbon stream, which is mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

### Example 6—Paper Fiber-Derived Feedstock and Petroleum-Derived Feedstock

A mixing system is configured according to any of the embodiments illustrated in FIGS. 1-4 and designed to process a total feed rate of 100 mt/hr. A first hydrocarbon feedstock is a straight-run kerosene derived from U.S. Gulf Coast crude oil and is fed at a rate of 80 mt/hr and a temperature of 40° C. A second hydrocarbon feedstock is a pyrolysis oil derived from mixed paper fiber recycling and is fed at a rate of 20 mt/hr and a temperature of 110° C. These dissimilar hydrocarbon feedstock materials are ordinarily incompatible, such that it would not be possible to create a stable conditioned hydrocarbon feedstock that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 10 ppm of the dispersed catalyst by weight of the feedstock. At least a portion of the straight-run kerosene and/or pyrolysis oil can function as the carrier oil. Alternatively, the carrier oil may comprise a conventional hydrocarbon diluent, such as atmospheric gas oil, vacuum gas oil, decant oil, cycle oil, fluid catalytic cracking (FCC)-derived oil, slurry oil, waste motor oil, hydrocarbon distillates having a nominal boiling in a range of 200° C. to 524° C., or a combination thereof. If a separate carrier oil and/or partial feedstock stream is used to form the diluted precursor mixture, it will comprise 2-3 wt % of the total feed and fed at a rate of 2-3 mt/hr. The diluted precursor mixture is combined with the remaining hydrocarbon feedstock materials.

The diluted precursor mixture is mixed with the remaining hydrocarbon feedstock materials to form an initial hydrocarbon stream, which is mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

### Example 7—Municipal Solid Waste-Derived Feedstock, Sewage Sludge-Derived Feedstock. and Petroleum-Derived Feedstock

A mixing system is configured according to any of the embodiments illustrated in FIG. 2 or 4 and designed to process a total feed rate of 100 mt/hr. A first hydrocarbon feedstock is a straight-run vacuum gas oil derived from North Sea crude oil and is fed at a rate of 75 mt/hr and a temperature of 100° C. A second hydrocarbon feedstock is a pyrolysis oil derived from municipal solid waste and is fed at a rate of 12.5 mt/hr and a temperature of 110° C. A third hydrocarbon feedstock is a pyrolysis oil derived from municipal sewage sludge and is fed at a rate of 12.5 mt/hr and a temperature of 110° C. These dissimilar hydrocarbon feedstock materials are ordinarily incompatible, such that it would not be possible to create a stable conditioned hydrocarbon feedstock that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 40 ppm of the dispersed catalyst by weight of the feedstock. At least a portion of the vacuum gas oil and/or pyrolysis oil can function as the carrier oil. Alternatively, the carrier oil may comprise a different hydrocarbon diluent, such as atmospheric gas oil, decant oil, cycle oil, fluid catalytic cracking (FCC)-derived oil, slurry oil, waste motor oil, diesel, kerosene, hydrocarbon distillates having a nominal boiling in a range of 200° C. to 524° C., or a combination thereof. If a separate carrier oil and/or partial feedstock stream is used to form the diluted precursor mixture, it will comprise 2-3 wt % of the total feed and fed at a rate of 2-3 mt/hr. The diluted precursor mixture is combined with the remaining hydrocarbon feedstock materials.

The second and third hydrocarbon feedstocks can be initially pre-mixed by a static inline mixer to form a hydrocarbon pre-mix. The hydrocarbon pre-mix is then combined with the diluted precursor mixture and first hydrocarbon feedstock to form an initial hydrocarbon stream, which mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

### Example 8—Mixing of Plastic-Derived Feedstock, Biomass-Derived Feedstock, and Waste Tire-Derived Feedstock

A mixing system is configured according to any of the embodiments illustrated in FIG. 2 or 4 and designed to process a total feed rate of 100 mt/hr. In this example, there is no petroleum-derived feedstock. A first hydrocarbon feedstock is a pyrolysis oil derived from biomass (plant matter) and is fed at a rate of 50 mt/hr and a temperature of 110° C. A second hydrocarbon feedstock is a pyrolysis oil derived from mixed plastics and is fed at a rate of 25 mt/hr and a temperature of 110° C. A third hydrocarbon feedstock is a pyrolysis oil derived from waste tires (demetallized) and is fed at a rate of 25 mt/hr and a temperature of 110° C. These dissimilar hydrocarbon feedstock materials are ordinarily incompatible, such that it would not be possible to create a stable conditioned hydrocarbon feedstock that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 30 ppm of the dispersed catalyst by weight of the feedstock. The carrier oil may comprise all or a portion of one of the hydrocarbon feedstock materials, a conventional hydrocarbon diluent, such as atmospheric gas oil, vacuum gas oil, decant oil, cycle oil, fluid catalytic cracking (FCC)-derived oil, slurry oil, waste motor oil, diesel, kerosene, hydrocarbon distillates having a nominal boiling in a range of 200° C. to 524° C., or a combination thereof. If a separate carrier oil and/or partial feedstock stream is used to form the diluted precursor mixture, it will comprise 2-3 wt % of the total feed and fed at a rate of 2-3 mt/hr. If the carrier oil is initially too hot, it can be cooled prior to being mixed with the catalyst precursor. The diluted precursor mixture is combined with the remaining hydrocarbon feedstock materials.

The diluted precursor mixture is mixed with the remaining hydrocarbon feedstock materials to form an initial hydrocarbon stream, which is mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

### Example 9—Used Cooking Oil and Petroleum-Derived Feedstock

A mixing system is configured according to the embodiment illustrated in FIG. 1 or FIG. 4 and designed to process a total feed rate of 250 metric tonnes per hour (mt/hr). A first hydrocarbon feedstock is a straight-run vacuum residue derived from distillation of Middle Eastern crude oil and is fed at a rate of 125 mt/hr and a temperature of 150° C. A second hydrocarbon feedstock is used cooking oil obtained from restaurants and/or food processing plants and is fed at a rate of 125 mt/hr and a temperature of 150° C. These dissimilar hydrocarbon feedstock materials are ordinarily incompatible, such that it would not be possible to create a stable, combined feedstock blend that can be processed using downstream equipment.

A catalyst precursor (molybdenum 2-ethylhexanoate) is mixed with a carrier oil by one or more static inline mixers to form a diluted precursor mixture which, when mixed with the bulk of the hydrocarbon feedstock and heated to decompose the precursor and form dispersed metal sulfide catalyst particles, will provide 20 ppm of the dispersed catalyst by weight of the feedstock. The carrier oil may comprise all or a portion of one of the hydrocarbon feedstock materials, a conventional hydrocarbon diluent, such as atmospheric gas oil, vacuum gas oil, decant oil, cycle oil, fluid catalytic cracking (FCC)-derived oil, slurry oil, waste motor oil, diesel, kerosene, hydrocarbon distillates having a nominal boiling in a range of 200° C. to 524° C., or a combination thereof. If a separate carrier oil and/or partial feedstock stream is used to form the diluted precursor mixture, it will comprise 2-3 wt % of the total feed and fed at a rate of 5-7.5 mt/hr. If the carrier oil is initially too hot, it can be cooled prior to being mixed with the catalyst precursor. The diluted precursor mixture is combined with the remaining hydrocarbon feedstock materials.

The diluted precursor mixture is mixed with the remaining hydrocarbon feedstock materials to form an initial hydrocarbon stream, which is mixed by one or more static inline mixers to achieve an initial degree of mixing. The initial blended feedstock mixture is then passed through a strainer, which removes larger insoluble particles which may otherwise cause operational difficulties with downstream equipment. After straining, the initial blended and strained feedstock mixture is processed in a high shear mixing system, which achieves a uniform blend of the feedstock materials to form a conditioned hydrocarbon feedstock in which the catalyst precursor is substantially homogeneously dispersed throughout the feedstock. The conditioned hydrocarbon feedstock is sufficiently stable and uniformly blended for processing in downstream equipment.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of dispersing a catalyst precursor into a hydrocarbon feedstock to form a conditioned hydrocarbon feedstock containing at least one nonpetroleum-derived hydrocarbon material for subsequent processing, comprising:
mixing a catalyst precursor with a hydrocarbon carrier oil by one or more static inline mixers to form a diluted precursor mixture; and
blending the diluted precursor mixture with a primary hydrocarbon feedstock material, and optionally a secondary hydrocarbon feedstock material, by one or more static inline mixers and one or more high shear mixers to form the conditioned hydrocarbon feedstock,
wherein the hydrocarbon carrier oil, the primary hydrocarbon feedstock material, and the optional secondary hydrocarbon feedstock material are independently selected from the group consisting of biomass-derived material, nonpetroleum-derived oil or fat, polymer, fabric or textile, paper or cardboard, rubber, waste product, pyrolysis product of one or more of the foregoing, petroleum-derived material, and combinations thereof, and
wherein at least one of the hydrocarbon carrier oil, the primary hydrocarbon feedstock material, or the optional secondary hydrocarbon feedstock material comprises a nonpetroleum-derived hydrocarbon material.

2. The method of claim 1, wherein the catalyst precursor comprises an oil-soluble organometallic compound or complex having a decomposition temperature in a range from about 100° C. to about 350° C. and that is comprised of at least one transition metal and at least one organic acid, carbonyl, or derivative thereof.

3. The method of claim 1, wherein the catalyst precursor comprises a transition metal selected from the group consisting of molybdenum, nickel, cobalt, vanadium, tungsten, iron and combinations thereof and a carboxylic acid or derivative thereof selected from the group consisting of 2-ethylhexanoic acid, octanoic acid, naphthenic acid, 3-cyclopentylpropionic acid, cyclohexanebutyric acid, biphenyl-2-carboxylic acid, 4-heptylbenzoic acid, 5-phenylvaleric acid, geranic acid (3,7-dimethyl-2,6-octadienoic acid), 10-undecenoic acid, dodecanoic acid, and combinations thereof.

4. The method of claim 1, wherein the catalyst precursor is selected from the group consisting of molybdenum 2-ethylhexanoate, nickel 2-ethylhexanoate, cobalt 2-ethylhexanoate, tungsten 2-ethylhexanoate, molybdenum octoate, molybdenum naphthenate, molybdenum dithiocarbamate, molybdenum diothiophosphate, molybdenum diothiophosphinate, vanadium naphthenate, vanadium octoate, molybdenum hexacarbonyl, vanadium hexacarbonyl, and iron pentacarbonyl.

5. The method of claim 1, further comprising blending the secondary hydrocarbon feedstock material with the diluted precursor mixture and the primary hydrocarbon feedstock material to form the conditioned hydrocarbon feedstock, wherein the secondary hydrocarbon feedstock material differs from the primary hydrocarbon feedstock material by at least one of chemical composition, polarity, solubility, or physical state, and wherein the secondary hydrocarbon feedstock material is selected from the group consisting of biomass-derived material, nonpetroleum-derived oil or fat, polymer, fabric or textile, paper or cardboard, rubber, waste product, pyrolysis product of one or more of the foregoing, petroleum-derived material, and combinations thereof, and wherein at least one of the primary hydrocarbon feedstock material or the secondary hydrocarbon feedstock material comprises a nonpetroleum-derived hydrocarbon.

6. The method of claim 1, wherein the hydrocarbon carrier oil and hydrocarbon feedstock material(s) are mixed using a plurality of parallel mixing lines, each parallel mixing line including one or more static inline mixers, one or more high shear mixers, and at least one valve for regulating flow in the mixing line.

7. The method of claim 1, wherein the biomass-derived material is selected from the group consisting of plant-derived material, lignocellulose, cellulose, lignin, starch, wood, wood residues, sawdust, wood chips, energy crops, hemp, straw, wheat straw, barley straw, stover, grasses, switch grass, maize, miscanthus, bamboo, husks, bagasse, silage, agriculture waste, seaweed, kelp, algae, pyrolysis products of one or more of the foregoing, and combinations thereof.

8. The method of claim 1, wherein the nonpetroleum-derived oil or fat is selected from the group consisting of vegetable oil or fat, animal fat or protein, used cooking oil, seed oil, nonpetroleum wax, pyrolysis products of one or more of the foregoing, and combinations thereof.

9. The method of claim 1, wherein the polymer is selected from the group consisting of high-density polyethylene (HDPE), low-density polyethylene (LDPE), polypropylene (PP), polystyrene (PS), polyester (PE), polyethylene terephthalate (PET), polybutylene terephthalate (PBT), polyetheretherketone (PEEK), polycarbonate (PC), acrylic, polymethacrylate, biopolymer, phenol-formaldehyde condensate, polyvinylchloride (PVC), bisphenyl-A, polyurethane (PUR), bioplastics, polyhydroxyalkanoate (PHA), polyhydroxy-butyrate (PHB), pyrolysis products of one or more of the foregoing, and combinations thereof.

10. The method of claim 1, wherein the fabric or textile is a product or structure comprising or derived from one or more materials or structures selected from the group consisting of cotton, polyester, linen, jute, nylon, spandex, wool, silk, leather, cloth, clothing, towels, rags, upholstery, carpet, geotextiles, drapes, shades, blinds, baskets, tablecloths, bedding, sheets, blankets, shower curtains, flags, backpacks, tents, nets, balloons, kites, sails, parachutes, pyrolysis products of one or more of the foregoing, and combinations thereof.

11. The method of claim 1, wherein the rubber is selected from the group consisting of isoprene, neoprene, tires, polybutadiene, styrene-butadiene copolymer, butyl rubber, ethylene propylene rubber, styrene-ethylene-butylene-styrene (SEBS), acrylic rubber, thermoplastic elastomer (TPE), pyrolysis products of one or more of the foregoing, and combinations thereof.

12. The method of claim 1, wherein the waste product is selected from the group consisting of municipal solid waste (MSW), sewage sludge, food processing waste, meat-processing waste, industrial waste products, pyrolysis products of one or more of the foregoing, and combinations thereof.

13. The method of claim 1, wherein the petroleum-derived material is selected from the group consisting of vacuum residue (straight-run or product from hydrocracking or hydroconversion process), vacuum gas oil (straight-run or product from hydrocracking or hydroconversion process), atmospheric residue, atmospheric gas oil, bitumen, visbreaker bottoms, resid pitch, heavy oil, deasphalted heavy oil, fluid catalytic cracking (FCC)-derived oil, slurry oil, cycle oil (light cycle oil or heavy cycle oil), decant oil, petroleum-based pyrolysis oil, waste motor oil, diesel, kerosene, and combinations thereof.

14. The method of claim 1, wherein the hydrocarbon carrier oil comprises at least one petroleum-derived material selected from the group consisting of atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C.

15. The method of claim 1, wherein the hydrocarbon carrier oil comprises at least one nonpetroleum-derived hydrocarbon.

16. The method of claim 1, wherein the primary hydrocarbon feedstock material comprises at least one petroleum-derived material selected from the group consisting of vacuum residue (straight-run or product from hydrocracking or hydroconversion process), vacuum gas oil (straight-run or product from hydrocracking or hydroconversion process), atmospheric residue, atmospheric gas oil, bitumen, visbreaker bottoms, resid pitch, heavy oil, deasphalted heavy oil, fluid catalytic cracking (FCC)-derived oil, slurry oil, cycle oil (light cycle oil or heavy cycle oil), decant oil, petroleum-based pyrolysis oil, waste motor oil, diesel, kerosene, and combinations thereof.

17. The method of claim 1, further comprising liquifying or comminuting any initially solid hydrocarbon carrier oil or hydrocarbon feedstock materials to a particle size of about 50 mesh (about 300 μm) or smaller, or about 70 mesh (about 210 μm) or smaller, or about 100 mesh (about 150 μm) or smaller.

18. The method of claim 1, wherein the conditioned hydrocarbon feedstock comprises 0% to 50% by weight of petroleum-derived material and 50% to 100% by weight of nonpetroleum-derived material.

19. The method of claim 1, wherein the conditioned hydrocarbon feedstock comprises 10% to 99% by weight of petroleum-derived material and 1% to 90% by weight of nonpetroleum-derived material, such as 50% to 99% by weight of petroleum-derived material and 1% to 50% by weight of nonpetroleum-derived material.

20. The method of claim 1, further comprising recycling a portion of the conditioned hydrocarbon feedstock by combining the recycled portion with at least one of the catalyst precursor, diluted precursor mixture, primary hydrocarbon feedstock material, or optional hydrocarbon feedstock material.

21. The method of claim 1, further comprising processing the conditioned hydrocarbon feedstock or upstream intermediate blend by processing equipment selected from N the group consisting of strainers, filters, pumps, furnaces, heat exchangers, reactors, separators, tanks, and distillation columns.

22. The method of claim 1, further comprising processing the conditioned hydrocarbon feedstock by one or more of ebullated bed hydrocracking or hydroconversion, fixed bed hydrocracking or hydroconversion, slurry bed hydrocracking or hydroconversion, solvent deasphalting, coking (delayed coking and/or Flexicoking), fluid catalytic cracking, hydroprocessing, or hydrotreating.

23. The method of claim 1, further comprising heating the conditioned hydrocarbon feedstock to cause at least a portion of the catalyst precursor to thermally decompose and form dispersed catalyst particles in situ.

24. A method of dispersing a catalyst precursor into a hydrocarbon feedstock to form a conditioned hydrocarbon feedstock containing at least one nonpetroleum-derived hydrocarbon material for subsequent processing, comprising:
mixing a catalyst precursor with a hydrocarbon carrier oil by one or more static inline mixers to form a diluted precursor mixture; and
blending the diluted precursor mixture with a primary hydrocarbon feedstock material and a secondary hydrocarbon feedstock material by one or more static inline mixers and one or more high shear mixers to form the conditioned hydrocarbon feedstock,
wherein the hydrocarbon carrier oil comprises at least one petroleum-derived material selected from the group consisting of atmospheric gas oil, vacuum gas oil, decant oil, cycle oil, fluid catalytic cracking (FCC)-derived oil, slurry oil, waste motor oil, diesel, kerosene, and hydrocarbon distillates having a nominal boiling in a range of 200° C. to 524° C.,
wherein the primary hydrocarbon feedstock material comprises at least one petroleum-derived material selected from the group consisting of vacuum residue (straight-run or product from hydrocracking or hydroconversion process), vacuum gas oil (straight-run or product from hydrocracking or hydroconversion process), atmospheric residue, atmospheric gas oil, bitumen, visbreaker bottoms, resid pitch, heavy oil, deasphalted heavy oil, fluid catalytic cracking (FCC)-derived oil, slurry oil, cycle oil (light cycle oil or heavy cycle oil), decant oil, petroleum-based pyrolysis oil, waste motor oil, and combinations thereof, and
wherein the secondary hydrocarbon feedstock material comprises at least one nonpetroleum-derived hydrocarbon material selected from the group consisting of biomass-derived material, nonpetroleum-derived oil or fat, polymer, fabric or textile, paper or cardboard, rubber, waste product, pyrolysis product of one or more of the foregoing, and combinations thereof.

25. A system for dispersing a catalyst precursor into a hydrocarbon feedstock to form a conditioned hydrocarbon feedstock containing at least one nonpetroleum-derived hydrocarbon material for subsequent processing, comprising:
a supply line for each of a catalyst precursor, a hydrocarbon carrier oil, a primary hydrocarbon feedstock material, and optionally a secondary hydrocarbon material;
one or more static in-line mixers configured to receive and mix the catalyst precursor with the carrier oil to form a diluted precursor mixture; and
a mixing system configured to receive and mix the diluted precursor mixture with the primary hydrocarbon feedstock material and optionally the secondary hydrocarbon feedstock material to form the conditioned hydrocarbon feedstock, the mixing system comprising one or more static in-line mixtures and one or more high shear mixers,
wherein the hydrocarbon carrier oil, the primary hydrocarbon feedstock material, and the optional secondary hydrocarbon feedstock material are independently selected from the group consisting of biomass-derived material, nonpetroleum-derived oil or fat, polymer, fabric or textile, paper or cardboard, rubber, waste product, pyrolysis product of one or more of the foregoing, petroleum-derived material, and combinations thereof, and
wherein at least one of the hydrocarbon carrier oil, the primary hydrocarbon feedstock material, or the optional secondary hydrocarbon feedstock material comprises a nonpetroleum-derived hydrocarbon material.

26. The system of claim 25, the system comprising a plurality of parallel mixing lines configured to receive and mix the diluted precursor mixture, primary hydrocarbon feedstock material, and optional secondary hydrocarbon feedstock material, each parallel mixing line including one or more static inline mixers, one or more high shear mixers, and at least one valve for regulating flow in the mixing line.
